(19) United States
(12) Patent Application Publication
(10) Pub. No.: US 2011/0320384 A1
(43) Pub. Date: Dec. 29, 2011

(54) Stock market filters

(76) Inventor: Cherng Chang, Rowland Heights, CA (US)

(21) Appl. No.: 13/134,860

(22) Filed: Jun. 20, 2011

Related U.S. Application Data
(63) Continuation-in-part of application No. 12/803,301, filed on Jun. 24, 2010.
Application No. 12/803,301 is a continuation-in-part of application No. 12/932,962, filed on Mar. 10, 2011.

(51) Int. Cl. G06Q 40/00

(52) U.S. Cl. 705/36 R

(57) ABSTRACT

Ten filters and two filter downloads are disclosed for further improving the capability of the present RTS software, as well as any real time stock software with filtering capability. The filter A is for filtering a specified list of stocks in order to find out all stocks, each having an up or down trend box signal(s). For each found TBS, a new data line comprising the TBS time, is added to the TBS list/filter sheet. The filter B is an extension of the filter A, by incorporating several alert features to call the attention of the user on the appearance of each TBS. The filter C is for finding stocks, each having a 5 min bar with its closing price higher or lower than the closing prices of last two or three 5 min bars. The filter D is for finding a group of three or four consecutive rising green or falling red 5 min bars. The filter E is for finding a stock having a 5 min bar above or below two or three prior 5 min bars. The filter F is for finding a stock having a 5 min bar representing a bullish or bearish reversal after any number of prior 5 min bars of same color. The filter G is for finding a stock meeting the NO % D criteria for long or short trade. The filter H is for finding a stock meeting the N % D criteria for long or short trade. The filter I allows a list of large number of stocks to be divided evenly into two or more smaller lists to be monitored by two or more persons. Filter J is for finding a sub-list of stocks, each having an assigned 1D TBS in each cycle of the trading day. Filter A Download allows Filter A 1D TBS filtering to be carried out at the Betrader site, and with obtained sub-list of stocks downloaded to each sign-up user at the market close. Filter J Download allows Filter J 1D TBS filtering to be carried out at the Betrader site, and with obtained sub-list of stocks downloaded to each sign-up user every 5 minutes.

This is a continuation-in-part of patent application Ser. No. 12/803,301, filed 2010 Jun. 24, and patent application Ser. No. 12/932,962, filed 2011, Mar. 10

### FIELD OF THE INVENTION

The present invention relates to methods providing a user stock market analysis and guide helpful for market entry.

### BACKGROUND OF THE INVENTION

In 2006, Betrader Financial Inc. (Cupertino, Calif.) released Version 2 of its RTS-STD real time stock software program. A more recent product RTS-PRO is available through its website http://www.betrader.com.

Once a user signs in RTS-PRO, a main viewing window 10 as shown in FIG. 1 will appear. The user may click the “New Chart” button 11 in this window to create a new chart in real time for his chosen stock. He can click the “New Quote” button 12 to enter one or more stocks to view and analyze. Such quote sheet may also display a group of indices designed by Betrader for viewing and analysis.

The “Show Layers” button 14 allows user to select one of four layers that RTS displays. Although the layers are numbered to identify them, they can be viewed in any order. The user can also choose to hide particular layers here.

The “New Scan” button 13, once clicked, will open a blank lift/filter sheet. This sheet has two buttons activatable by the user. The first one is a “List” button 32, shown in FIG. 3, which allows the user to open a list either from the market in real time or the user's stock listing files. The second button is a “Filter” button 33, also shown in FIG. 3, which allows the user to select one or more pre-designed filtering criteria to be applied to the above list for selecting and opening a subgroup of stocks in this list meeting said criteria for viewing and analysis by the user.

Shown in FIG. 2 is a current version of the list filter panel 20 in the RTS-PRO program. It is opened once the Filter button 33 is clicked. For example, an intraday trader only wants to trade stocks satisfying the following conditions:

1. Daily trading volume larger than 800,000 shares. This is achieved as shown in FIG. 2 by clicking the box 21 next to “Average Volume Greater Than” and entering “800” in the box 22 to the right.

2. Stock price greater than $30. This is achieved by clicking the box 23 next to “Price Greater Than” and entering “30” in the box 24 to the right.

3. Trading volume 180% or more of the average trading volume. This is done by clicking the box 25 next to “Vol/Ave Vol Greater Than”, and then entering “180” in the box 26 to the right. Once all above conditions have been made as shown in FIG. 2, the user will click the “OK” button 28 and open a list/filter sheet, or a filter sheet.

FIG. 3 shows the list/filter sheet 30 listing 10 stocks meeting the filtering criteria specified as shown in FIG. 2. This list/filter sheet is color linked with a chart display window 40 shown in FIG. 4. This display window is set to display on the layer 3 which is shown on a 42″ TV acting as a terminal extension to the PC station. The screen size of this TV is large enough to display 20 charts, for 10 stocks each having a 1 day and 5 min chart pair. One pair 41 is set aside for displaying a reference, such as Dow Jones, SP 500 or Nasdaq, while the other nine pairs 42 are linked to the list/filter sheet 30 shown in FIG. 3, using a common color of, say, blue 43 on the upper right corners of each stock chart and the list/filter sheet. Since only nine stocks can be displayed, the number 10 stock is not shown, but can be displayed by sliding the right cursor 34 on the list/filter sheet downward. Using the present RTS-PRO, it may take only about ten seconds to set these criteria and find the stocks. On the other hand, it would take much longer time to find such information using other methods.

In the RTS-PRO, a stock chart is typically represented by a group of candlesticks. Each candlestick, a popular type of stock price bar, comprises a body section or bar, and two lines vertically extending from the bar. The bar indicates the opening and closing price of a stock in a unit of 1 day, 1 week, 5 min or other time period. A white or green bar indicates a rising price, and a black or red bar indicates a falling price. The two black lines, if seen, indicate the highest price and lowest price during this period.

In the RTS-PRO, a term “trend box” (TB) is employed, which is a box covering one or more candlesticks. Similar to the candlestick, a TB can also be either green or red, lay on top of the corresponding candlestick(s).

When there is a new green candlestick appeared with its close exceeding the high of the preceding green trend box, a new green trend box is formed, usually. The high of this new green TB will be equal to the close of this new green bar. The low of this new green trend box is automatically set the same as the high of the preceding TB. This green trend box will continue cover all succeeding candlesticks until a new trend box is formed.

Conversely, when there is a new red bar appeared, with its close falling below the low of the preceding green TB, a new red TB is formed, usually. The low of this new red TB will be assigned same as the close of the new red bar. The high of this new red TB will be the same as the low of the preceding green TB. This red TB will be extended until another new TB is formed. The formation of a new red or green trend box right after a red TB can also be similarly constructed.

In the RTS-PRO, a term “trend box signal” (TBS) is also used. This TBS is similar to a conventional three lines break (3LB), which usually refers to a trend reversal when a rising bar immediately follows three consecutive falling bars or a falling bar immediately follows three consecutive rising bars. Such trend reversal represents a good time for entry either for long or short, respectively.

In RTS-PRO, a TBS can be either an up green arrow or a down red arrow. A green TBS is assigned to a price chart at a place where there is a reversal typically from three consecutive red trend boxes to a green trend box, while a red TBS is assigned to a price chart at a place where there is a reversal typically from three consecutive green trend boxes to a red trend box. This trend box reversal is an improvement over the conventional 3LB, mainly due to the elimination of some noise associated with the use of candlesticks, and makes the reversal more reliable.

In RTS-PRO, the TBS is placed in the chart to point out the best time for a trader to enter a long trade or short trade. There is a filter 27 in RTS-PRO, “TB Bullish or Bearish Reversal After ______ same color TB”, as seen in FIG. 2. There are two problems with this filter. First, there is no indication of the timing on the appearance of a TBS. Very often the golden opportunity for profitable trade presented by each TBS only last as short as 5-10 minutes. If the user executes this filter, say, 3 hours after the New York stock opening, he will get a listing of many stocks meeting the filter criteria having at least one TB reversal. But the problem is that the golden opportunity for profitable trade represented by the reversals offered by this filter have long gone and become useless. Lot of precious time would be wasted in going through all these charts and then found that they are useless.

There is also one serious problem with this filter 27 in that it does not uncover all TBSs assigned by the RTS-PRO during a specified time period. For example, the execution of this filter 27 (Bullish Reversal After 3 Same Color TBs) near the close of Oct. 5, 2010 stock market for a list of 259 sector stocks presents a total of only nine stocks in the corresponding list/filter sheet for that specified time period of 6.5 hrs. But a manual examination of all charts of these 259 stocks, it was found that there are more than 181 stocks each showing one or more up TBSs for that day of 6.5 hrs stock opening period. Each of these TBSs may present an opportunity of profitable trading if such a trade can be made within 5 min or less of the assignment of this TBS.

Therefore, it would be more beneficial that a filter could be devised not only to find out all stocks assigned with TBSs, but also capable of reporting each TBS, immediately after its assignment, in the corresponding list/filter sheet, both the name of this stock and its TBS assignment time, preferably accompanied by one alert calling the attention of the trader on the occurrence of each one such TBS. It would assure that all reported stocks are not only fresh, but also valid with its TBS assurance.

### SUMMARY OF THE INVENTION

Ten filters and two filter downloads are disclosed for further improving the capability of the present RTS software as well as any real time stock software with filtering capability. Most of these filters are mainly applied for intraday swing trading, in which both buy and sell of the same stock are done in a single day. But it may also be used for multiple days swing trading if the market condition favors the holding of the purchased stocks for more than one day.

The filter A is for filtering a specified list of stocks in order to find out all stocks, each having at least one assigned up or down trend box signal, TBS, in this stock's price chart. For each found up or down TBS, the TBS subroutine will add to the TBS list/filter sheet one new data line, comprising the TBS time, stock symbol, TBS price, last price, and derived data for this stock. Both the last price and derived data will get updated from cycle to cycle. But the TBS time and TBS price will stay unchanged throughout the remaining stock market day.

The most important advantage of the filter A is its TBS list/filter sheet, which provides the user the information of this TBS, along with its time and price, typically within the first minute after its appearance. This information, coupled with the linked stock chart display and the placed TBS on this chart, provides the user a favorable timely opportunity for market entry. As long as the market is in an upward trend, this up TBS almost, but not always, assures a winning long trade potential. The potential profit will be larger the earlier the trade can be made. The same is true for a profitable short trade potential, during a down TBS time and in a downward market trend.

The filter B is an extension of the filter A, by incorporating several alert features to call the attention of the user on the appearance of each TBS. First, the stock symbol of each created new data line in the list/filter sheet will appear in bright green or red color. Second, a new column is added to the list/filter sheet to house one bright green or red arrow in each new data line. These arrows may even be flashing in its initial 5-10 minutes to make this alert more prominent. Finally, a vocal announcement may also be provided to supplement all visual alerts.

The filter C is for filtering a stock list in finding stocks each having a 5 min bar with its closing price either higher or lower than the closing prices of last two or three 5 min bars. The appearance of such bar may point out the rising or falling price trend of stock, suitable for trade entry.

The processing of the filter C starts with defining each 5 min bar, and finding the closing price of this bar and the closing prices of two or three prior 5 min bars. Once a 5 min bar meeting the filtering criteria is found, a new data line is added to the closing price-closing price list/filter sheet. Alerts including green/red stock symbols, color flashing arrows, and vocal announcements may also be provided.

The filter D is for filtering a stock list in finding each stock having a group of three or four consecutive rising green or falling red 5 min bars. Such a continuously rising or falling price in a stock may present a trend and suggest a favorable chance for trade entry.

The processing of the filter D starts with defining each 5 min bar and finding the opening and closing prices of both the current 5 min bar and two or three preceding 5 min bars. Once such consecutive rising or falling bars are found, a new data line is added to the consecutive bars list/filter sheet. All above described alerts may also be provided.

The filter E is for filtering a stock list in finding each stock having a 5 min bar with closing price above or below two or three prior 5 min bars. Once a stock is found meeting the filter E criteria, a new data line will be added to the closing price-bars list/filter sheet. All above described alerts may also be provided.

The filter F is related to a term Three Line Break, TLB, which is now broaden to refer to a bullish or bearish reversal after any number of prior 5 min bars of same color. With the processing of this filter, once a stock is found meeting the filter F criteria, a new data line will be added to the TLB list/filter sheet. All above-described alert features may also be provided.

In the filter G, a term “NO % D” is used, which is defined as the difference between NO % of a stock and NO % of a reference such as $SPX. A positive NO % D for a stock means this is a strong stock with good fundamental.

For a long trading based on the NO % D filter G, the user has the choice to decide whether the NO % D value must be above 0%, 1%, or any positive percentage entered by the user. A NO % D list/filter sheet, which included a column listing the value of all internally calculated NO % D, will display all stocks meeting the NO % D G criteria. This sheet will also color link with the display of all NO % D charts of the filtered stocks as well as their price charts.

For the filter H, a new term N % D is introduced, which equals to N % (Stock)−N % ($SPX), if the reference is $SPX.

Similar to NO % D, a positive N % D also means this stock is a strong stock with good fundamental. The filtering of the filter H is also similar to the filter G, but is more likely used for multiple days swing trading.

The filter I allows a large group of stocks to be evenly divided into two or more smaller groups to be monitored by two or more persons. It can be divided into two or more subgroups based on the alphabets of the stocks. A group of consecutively numbered stocks can be divided into one group with even numbers and one group with odd numbers. It can also be divided into x subgroups according to the remainder values after division.

The Filter J is a filter for filtering a list of stocks for finding a sub-list of stocks, each having an up or down 1D TBS assigned to this stock's price chart in each operation cycle during the trading day. Upon each finding, the obtained sub-list of stocks will be placed in a list/filter sheet, replacing all stocks placed there in the previous cycle.

The Filter A Download allows Filter A 1D TBS filtering to be carried out at the Betrader Company site over a list of 3,000 stocks. The obtained sub-list of stocks each having a 1D TBS assigned to this stock's price chart can be downloaded to each sign-up user on a fee basis.

The Filter J Download allows Filter J 1D TBS filtering to be carried out at the Betrader Company site over a list of 3,000 stocks. The obtained sub-list of stocks each having a 1D TBS assigned to this stock's price chart can be downloaded once every 5 minutes to each sign-up user on a fee basis.

### BRIEF DESCRIPTION OF THE DRAWINGS

FIG. 1 shows the main viewing window opened at the start of the RTS-PRO program.

FIG. 2 shows a list filter panel of the RTS-PRO program.

FIG. 3 shows a list/filter sheet displaying a group of stocks meeting the filtering criteria specified in the list filter panel as shown in FIG. 2.

FIG. 4 shows a 42″ TV screen acting as a PC terminal extension for displaying 20 charts for viewing.

FIG. 5 shows a list of ten filters and two filter downloads of the present invention and criteria for each filter to be specified by the user.

FIG. 6 shows a flow diagram of the filter A filtering process for finding all stocks among the eight utility stocks that each has an assigned up TBS during the closing cycle of each 5 min bar, and listing each TBS immediately after its finding.

FIG. 7 shows an up TBS list/filter sheet, created after clicking the filter A box, and before any up TBS has been found.

FIG. 8 shows the up TBS list/filter sheet, with the filter A in process, when a first up TBS for the stock PCG was found, and a new data line for this stock was placed.

FIG. 9 shows the up TBS list/filter sheet after the close of the stock market. A total 14 new data lines were placed.

FIG. 10 shows the result of simulated trading of the eight utility stocks on Jul. 20, 2010, based on TBS.

FIGS. 11 and 12 show the tabulated and graphic representation, respectively, of the stock account balance during the Jul. 20, 2010 simulated trading as shown in FIG. 10.

FIG. 13 shows the comparison on the results of simulated trading of WEC stock on Jul. 20, 2010 based on TBS at different buy times.

FIG. 14 shows the price chart of the WEC stock on Jul. 20, 2010, along with the display of the up and down TBSs on this stock.

FIG. 15 shows an abbreviated flow diagram of the filter A filtering process for finding all stocks among the eight utility stocks that each has an up or down TBS during the closing cycle of each 5 min bar, and listing each TBS immediately after its finding.

FIG. 16 shows an abbreviated flow diagram of the filter B filtering process for finding all stocks among the eight utility stocks that each has an up or down TBS during the closing cycle of each 5 min bar, and listing each TBS immediately after its finding. All added up TBS stock symbols are shown in green color. All added down TBS stock symbols are shown in red color.

FIG. 17 shows an abbreviated flow diagram of the filter B, which provides several alerting features including colored TBS stock symbols, arrows, and vocal announcement for each filtered TBS.

FIG. 18 shows the up TBS list/filter sheet in which both the up arrow alerts and the stock symbols are shown in green color.

FIGS. 19 and 19′ show two closing price-closing price list/filter sheets for the filter C.

FIG. 20 shows the flow diagram of the filter C for filtering the eight utility stocks in finding stocks each having a 5 min bar with its closing price higher than the closing prices of prior two 5 min bars.

FIG. 20′ shows the flow diagram of the filter C for filtering the eight utility stocks in finding stocks each having a 5 min bar with its closing price higher than the closing prices of prior three 5 min bars.

FIGS. 21 and 21′ shows two tables of bar prices of WEC for the filter C.

FIGS. 22 and 22′ show a section of the stock WEC price chart for demonstrating the processing of the filter C.

FIG. 23 shows the flow diagram of the filter D for filtering the eight utility stocks in finding stocks each having three consecutive rising green 5 min bars.

FIG. 23′ shows the flow diagram of the filter D for filtering the eight utility stocks in finding stocks each having four consecutive rising green 5 min bars.

FIGS. 24 and 24′ show a section of the stock WEC price chart for demonstrating the processing of the filter D.

FIGS. 25 and 25′ shows two tables of bar prices of WEC for the filter D.

FIGS. 26 and 26′ show two consecutive bars list/filter sheets.

FIGS. 27 and 27′ show two closing price-bars list/filter sheets.

FIG. 28 shows the flow diagram of the filter E for filtering the eight utility stocks in finding stocks each having a 5 min bar with its closing price higher than prior two 5 min bars.

FIG. 28′ shows the flow diagram of the filter E for filtering the eight utility stocks in finding stocks each having a 5 min bar with its closing price higher than prior three 5 min bars.

FIGS. 29 and 29′ show a section of the stock WEC price chart for demonstrating the processing of the filter E.

FIGS. 30 and 30′ shows two tables of bar prices of WEC for the filter E.

FIGS. 31 and 31′ show two TLB list/filter sheets.

FIG. 32 shows the flow diagram of the filter F for filtering the eight utility stocks in finding stocks each having a 5 min bar representing a bullish reversal after two preceding same color 5 min bars.

FIG. 32′ shows the flow diagram of the filter F for filtering the eight utility stocks in finding stocks each having a 5 min bar representing a bullish reversal after three preceding same color 5 min bars.

FIGS. 33 and 33′ show a section of the stock WEC price chart for demonstrating the processing of the filter F.

FIGS. 34 and 34′ shows two tables of bar prices of WEC for the filter F.

FIG. 35 shows a long NO % D list/filter sheet, created after clicking activation of the filter G for long, but before any stock meeting the long NO % D filter G criteria.

FIG. 36 shows a flow diagram of the filter G, for filtering the list of 259 stocks, in order to find out in each cycle, all stocks each having a NO % D value higher than 1%, and place all these stocks with their related data in the long NO % D list/filter sheet.

FIG. 37 shows the same flow diagram of the filter G as shown in FIG. 36, except that in the flow diagram of FIG. 37, the calculation and recording of NO % D are now part of the pre-filtering tasks and can be automatically updated from cycle to cycle.

FIG. 38 shows the long NO % D list/filter sheet, with the filter G in process, when the stock IBM was found meeting the long NO % D filter G criteria.

FIG. 39 shows three price charts of IBM (1 D, 5 min, 1 Min) and a manually created chart of NO % D for IBM on Apr. 26, 2010. All these charts can be displayed through color link with the NO % D list/filter sheet under the modified RTS program.

FIG. 40 shows a flow diagram of the filter G, for filtering the list of 259 stocks, in order to find out in each cycle, all stocks each having a NO % D value less than −1.5%, and place all these stocks with their related data in the short NO % D list/filter sheet.

FIG. 41 shows a flow diagram of the Filter A 1D up TBS filter of the present invention.

FIG. 42 shows a 1D TBS List/Filter sheet at the close of one trading day.

FIG. 43 shows the 1D price chart of $SPX during the early part of year 2009.

FIG. 44 shows, through manual checking, lists the appearance (1) and disappearance (0) of 1D up TBSs in the 259 sector stocks on Apr. 28, 2011 trading day at the time shown.

FIG. 45 shows a flow diagram for Filter J.

FIG. 46 shows the 1D up TD TBS List/Filter sheet listing a total of seven stocks at 10:00 EST of Apr. 28, 2011.

FIG. 47 shows the 1D charts of the stocks AEM, AMX, BHI, NOV and OXY from May 10, 2011 to Jun. 1, 2011.

FIG. 48 shows the 5 min charts of the stock OXY on May 24, 2011 and May 25, 2011.

FIG. 49 shows the 5 min charts of the stock OXY on May 26, 2011 and May 27, 2011.

FIG. 50 shows the 5 min charts of the stock OXY on May 31, 2011 and Jun. 1, 2011.

FIG. 51 shows the result of simulated trading of OXY based on 1D up TBS at May 24, 2011.

FIG. 52 shows the flow diagram of Filter A Download: Stocks with 1D TBSs at Market Close.

FIG. 53 shows the flow diagram of Filter J Download: Stocks with 1D TBSs during the trading day.

FIGS. 54, 54′ and 54″ are OXY 1D charts ending at 16:00 EST, 11:00 EST and 12:00 EST, respectively, on May 24, 2011.

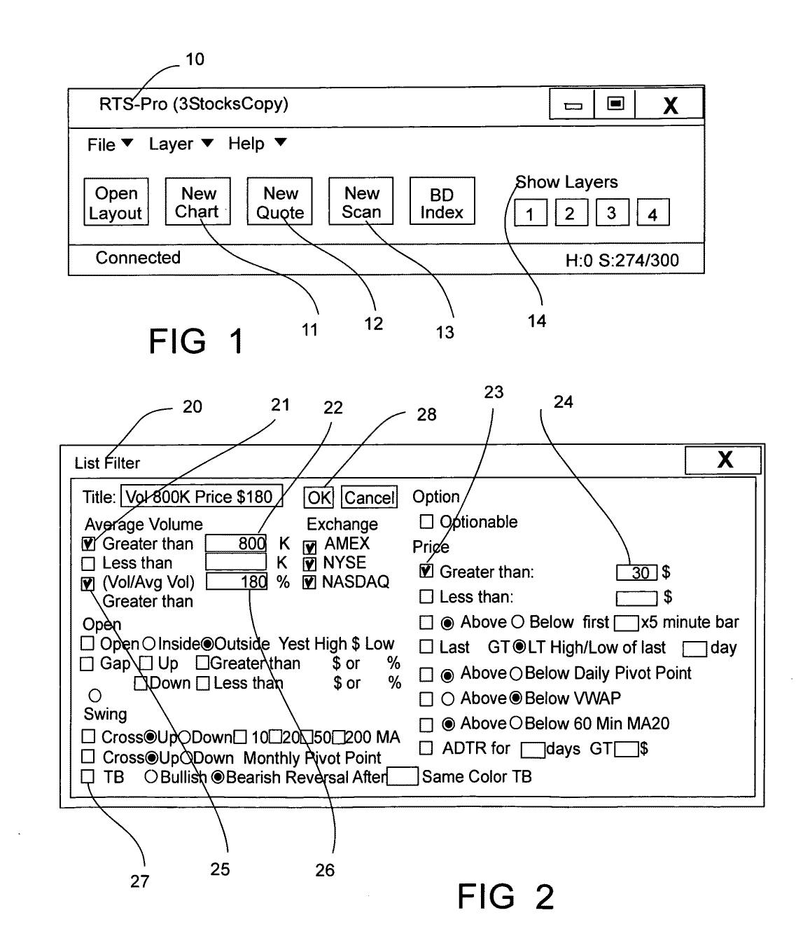

### DETAILED DESCRIPTION

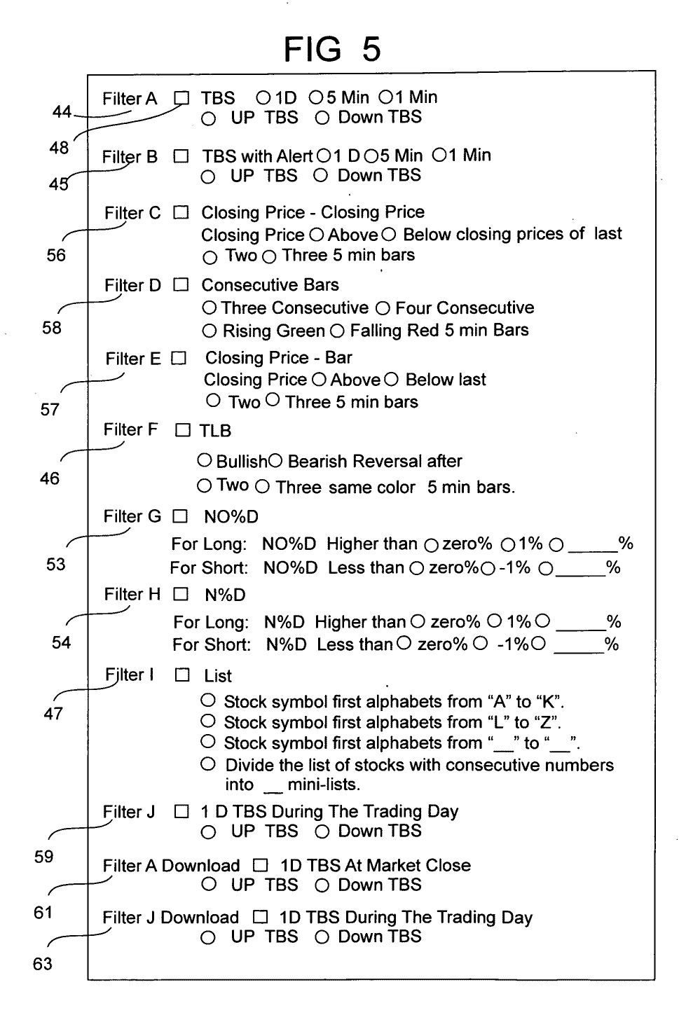

Shown in FIG. 5 are ten filters and two filter downloads for further improving the capability of the present RTS software as well as any real time stock software with filtering capability. These ten filters are mainly applied for intraday swing trading, in which both buy and sell of the same stock are done in a single day. But it may also be used for multiple days swing trading if the market condition favors the holding of the purchased stocks for more than one day.

For the sake of explanation, a new term “modified RTS-PRO” is used here to refer to the current RTS-PRO program that has been modified to incorporate all needed revision for successfully running all ten filters of the present invention. Although such modified RTS-PRO program is not yet in existence, any person skilled in the art would be able to make such modification based on the teaching of the present application. In order to make the distinction, the term “RTS-PRO”, as opposed to “modified RTS-PRO”, from now on will refer to the current RTS-PRO program without such modification.

### Filter A: TBS

In this section a new kind of list/filter sheet is disclosed. Before the description of this new sheet, a brief discussion of the list/filter sheet employed in the current version of RTS is necessary. When a filter used by RTS is activated, it is always used to filter an employed list, either a real time or pre-selected list, according to the filter's criteria. The result of this filtering is a subset of the employed list successfully passing the criteria of the filter. This subset of stocks, along with all derived data, are then placed in the list/filter sheet, replacing the subset stocks previously placed in the list/filter sheet. This new subset of stocks will be visible to the user for providing the needed information for making his trading decision. This new subset of stocks will remain in place until the next round of filtering when it is replaced by yet another newer subset of stocks. One problem with this type of list/filter sheets is the fluctuation of the displayed stocks and their linked charts. An entered stock and its chart may suddenly disappear in front of the trader. In order to preserve the stocks of interest, the trader must manually retype in all these stocks of interest in one other list sheets for monitoring. Such manual operation would certainly slow down the trading efficiency.

The present proposed TBS list/filter sheet concept can best be explained by an example based on the trade market data of eight utility stocks in Jul. 20, 2010. In this example, a new filter as shown in FIG. 5 is proposed to be incorporated into the RTS program.

Before the stock market opening, the user can create a TBS list/filter sheet by selecting, for example, the eight utility stocks as its list. He needs to click either the up TBS or the down TBS, but not both, in the filter and activate this filter after the stock market open. If the user wants to find both the up TBS and the down TBS, he must create two separate list/filter sheets, one for finding the up TBS, while the other one for finding the down TBS in the eight utility stocks.

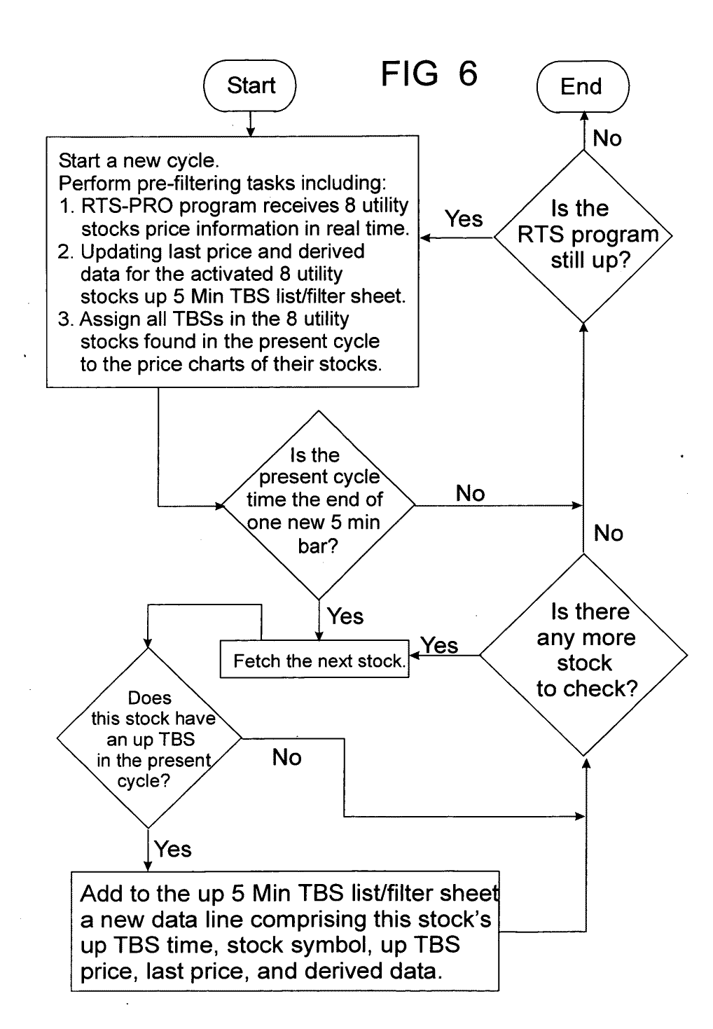

Before discussion of the filter A of the present invention for reporting the assigned TBS in a stock, one detail on the assignment of a TBS by the existing RTS program on a stock price chart need to be clarified. The computer program on the finding, assigning, and recording of a TBS on a stock price chart is working in a cyclic mood, but the stock's price chart is presented in the form of a series of candlesticks. Each candlestick bar may have a duration of 1 min, 5 min, 1 day, or even 1 week. In this Applicant's prior application (Ser. No. 12/932,962, Filed Mar. 10, 2011), a flow diagram shown in FIG. 6 was presented for obtaining from a list a subset of stocks, each having an assigned 5 min up TBS in its price chart. This flow diagram is correct as long as the duration of each computer cycle is assumed to be the same as the duration of the candlesticks presented in the price chart.

However, the duration of each computer cycle is usually much shorter than the duration of one bar. So if one TBS was first found during the mid of a bar, and visible on the computer screen, this TBS will disappear from the screen during the latter cycles of the same bar if the stock price no longer meets the requirements of the TBS criteria. So the actual permanent assignment of this 5 min TBS on the price chart only occurs at the last cycle of the 5 min bar when the last price of this 5 min bar meets the TBS criteria. A red TBS is normally placed above this bar, while a green TBS is placed below this bar, at close distance, but separate from the bar.

FIG. 6 shows the flow diagram for the present new filter in finding such stocks from a list of 8 utility stocks, each having one or more up TBSs assigned to their 5 min bar price charts. It should be noted that the FIG. 6 flow diagram shows that in each cycle, the stated pre-filtering tasks including receiving stock prices, updating the last price and derived data in the list/filter sheet, and assignment of TBSs in the price charts, are done by the existing RTO-PRO program, not part of the filter A to be introduced here. It is seen in this flow diagram, that the work of the filter A in finding the assigned TBSs immediately following the TBS assignment is only done in the last cycle, or closing cycle, of the 5 min bar. Once an assigned TBS in a stock's price chart is found, the needed TBS time is simply the close time of the present 5 min bar, the TBS price is simply the last price of this stocks' 5 min bar, all of which are readily available for the task of the filter A.

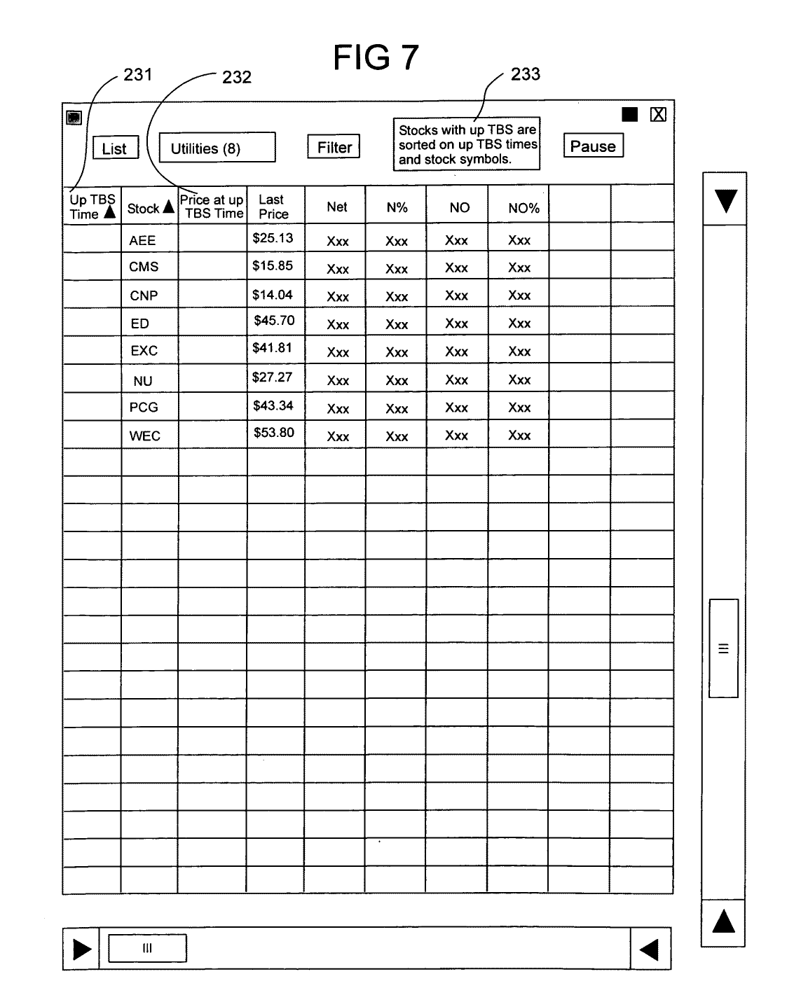

In the present example, it is assumed that the trader clicks the “New Scan” button and selects the 8 utility stocks as its list. He then clicks the “Filter” button, which will open a List Filter panel such as the one shown in FIG. 2, but by now including all 10 filters and two filter downloads shown in FIG. 5, listed in this panel. He will then choose Filter A, 5 Min, and Up TBS, and click its “OK” button 48, as seen in FIG. 5. A new TBS List/Filter sheet will appear as shown in FIG. 7.

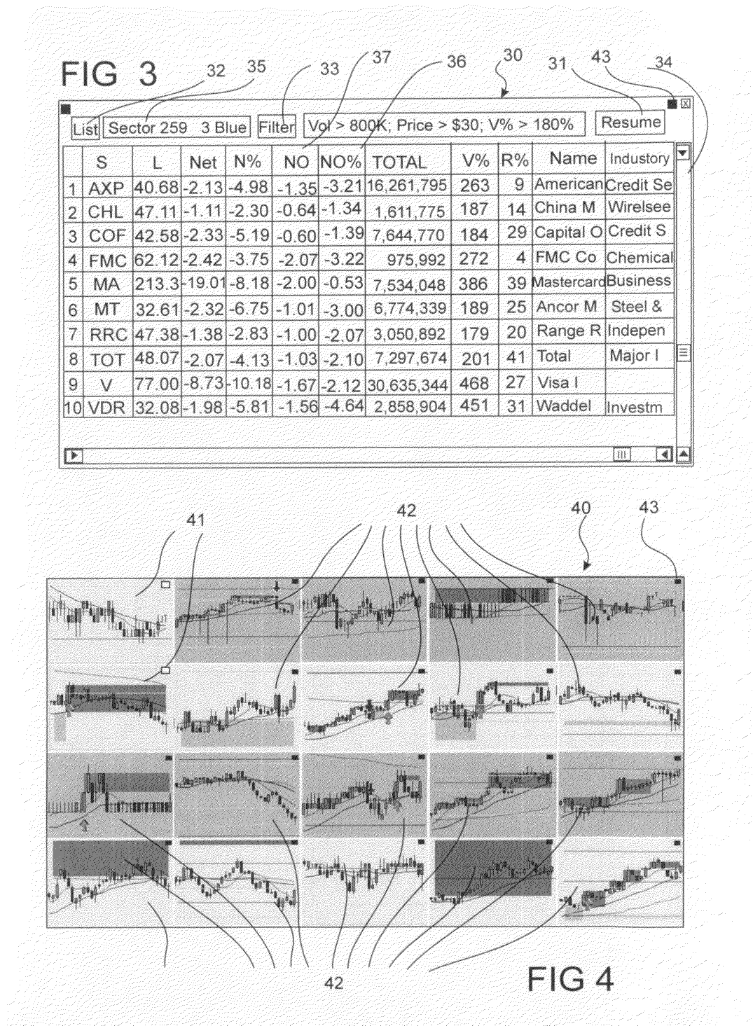

Compared with the regular list/filter sheet typically shown in FIG. 3, this TBS list/filter sheet has two new columns. If this filter is for up TBS, the headings for these two columns will be “Up TBS Time” for the column 231, and “Price at up TBS Time” for the column 232. As seen in FIG. 7, a box 233 next to the Filter box will be filled by the sentence “Stocks with up TBS are sorted on TBS times and stock symbols.” as a default setting. Two up black triangles are automatically added to the box 231 heading, and the “Stock” heading next to it.

In this TBS list/filter sheet, the column 231 shows the time when an up TBS is assigned to a stock, which is the close time of the present bar. The column 232 shows the stock price at its up TBS time, which is the last price of the present bar. Prior to the stock opening, all these two columns will remain empty.

Similar to FIG. 3, the last prices of these eight utility stocks are displayed in FIG. 7. Prior to stock opening, these values are the previous day's closing prices. The values for the Net, N %, NO, and NO %, referred to as derived data, are simply represented by the marks “Xxx” because they are not relevant to the present discussion.

Starting the trade opening, the current RTS software will continue process the market data including that of the eight utility stocks. The filter A of the present invention, if activated, will also be processed in each cycle according to the flow diagram shown in FIG. 6. As long as no assigned up TBS in a bar closing cycle is found, no new line will be added to the TBS List/Filter sheet. However, the listed last prices, net, N %, NO, and NO % for all these eight stocks do get updated in each cycle as needed.

During a bar closing cycle at around 10:55 EST that day the existing RTS program assigned an up TBS to the price chart of the stock PCG, having price meeting the qualification for an up TBS. Shortly after this assignment the filter A subroutine found this assigned up TBS along with its up TBS time and price. This subroutine subsequently adds a new data line below the first eight utility stocks lines originally created before stock opening, and updated in each cycle.

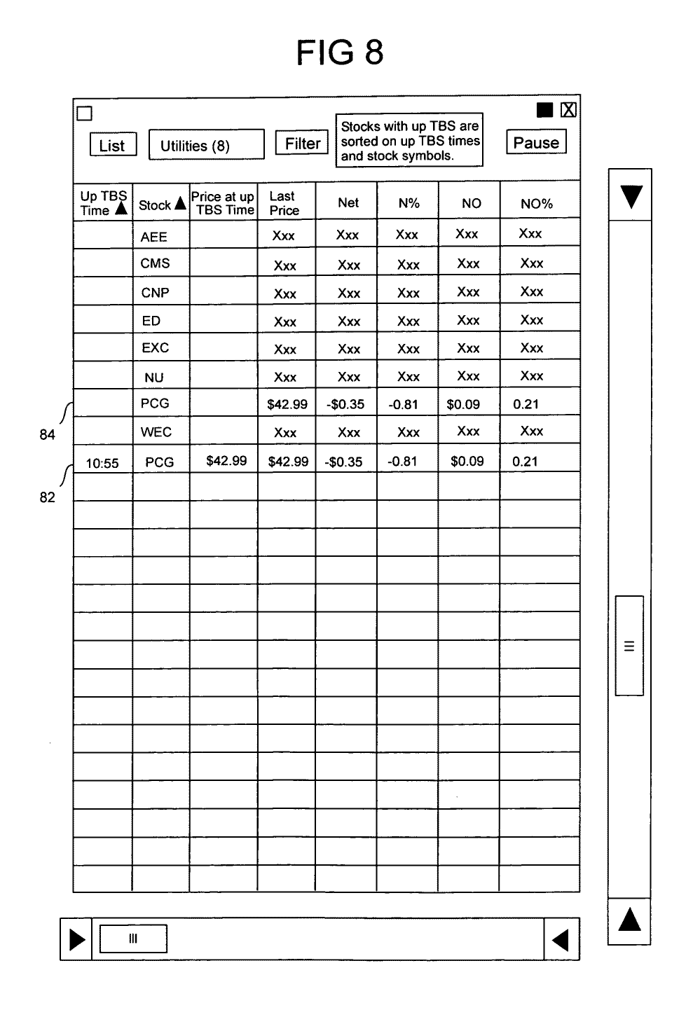

FIG. 8 shows the TBS list/filter sheet just after the action above described. It is seen in FIG. 8 that this new data line 82 for the stock PCG is essentially the same as the PCG line 84 listed as one of the eight utility line, except that the TBS time of 10:55 and TBS price of $42.99 are now added to the new data line 82. From now on this new data line 82 will be treated the same as the PCG line 84 and get updated from cycle to cycle. But the TBS time 10:55 and TBS price $42.99 will stay unchanged throughout the trading day. It is also noted that this new data line 82 is added to the TBS list/filter sheet without removing any data row previously entered.

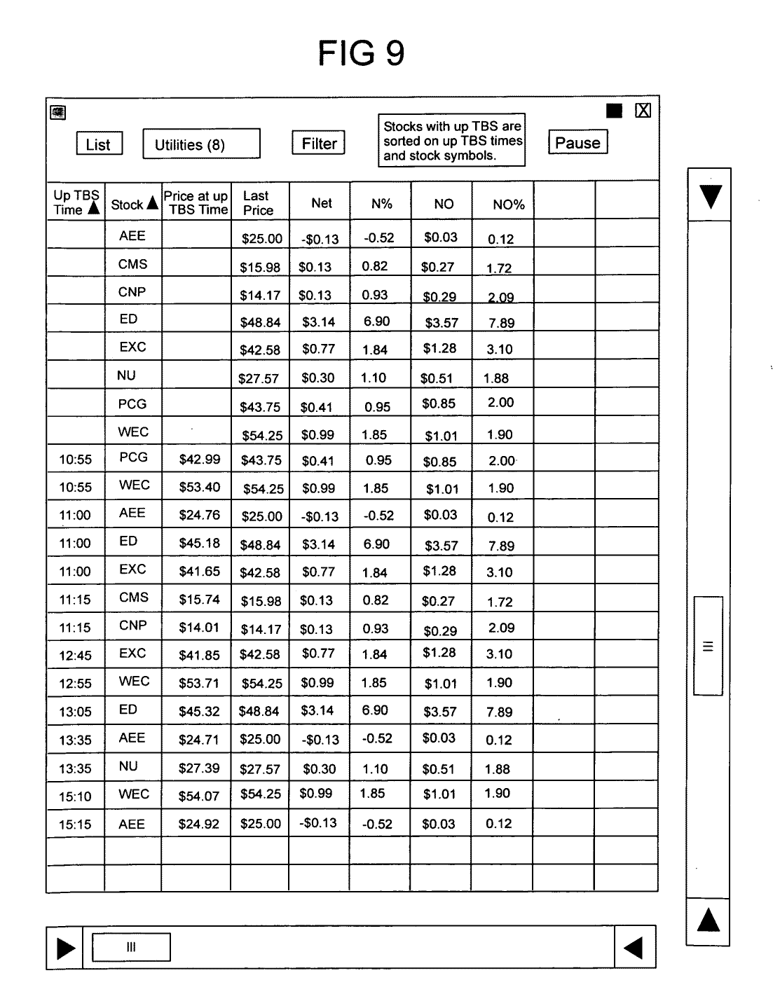

With the progress of time, more and more assigned up TBS will be found and added to the TBS list/filter sheet. FIG. 9 shows this sheet at the close time of the stock market. All listed last prices in this sheet are the closing prices of these stocks for the day. This sheet will stay the same until the opening of the next day's stock market.

As seen in FIG. 9, there are a total of fourteen (14) up TBSs from these eight stocks during this stock market day. This TBS list/filter sheet is also color-linked with chart display of these stocks. If the chart display window can not display all stocks of interest, the user can easily move the curser up or down to bring some of these stocks within the display window.

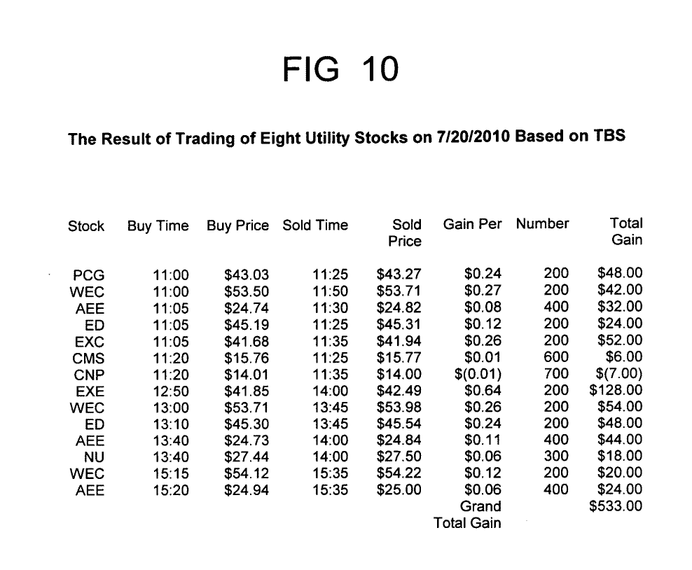

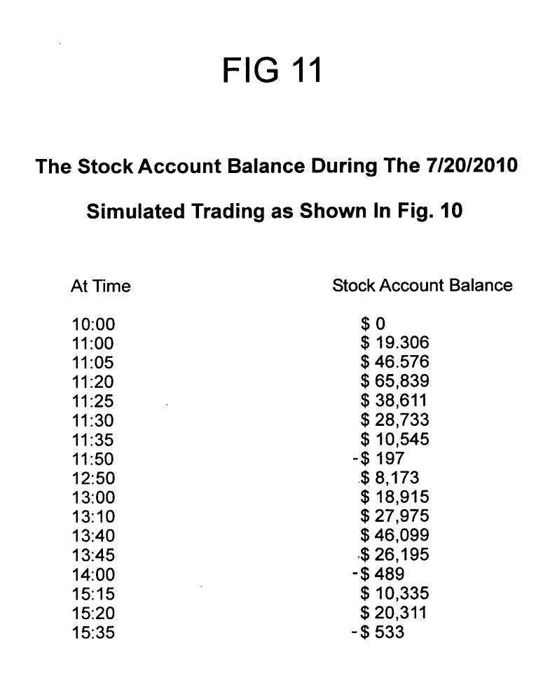

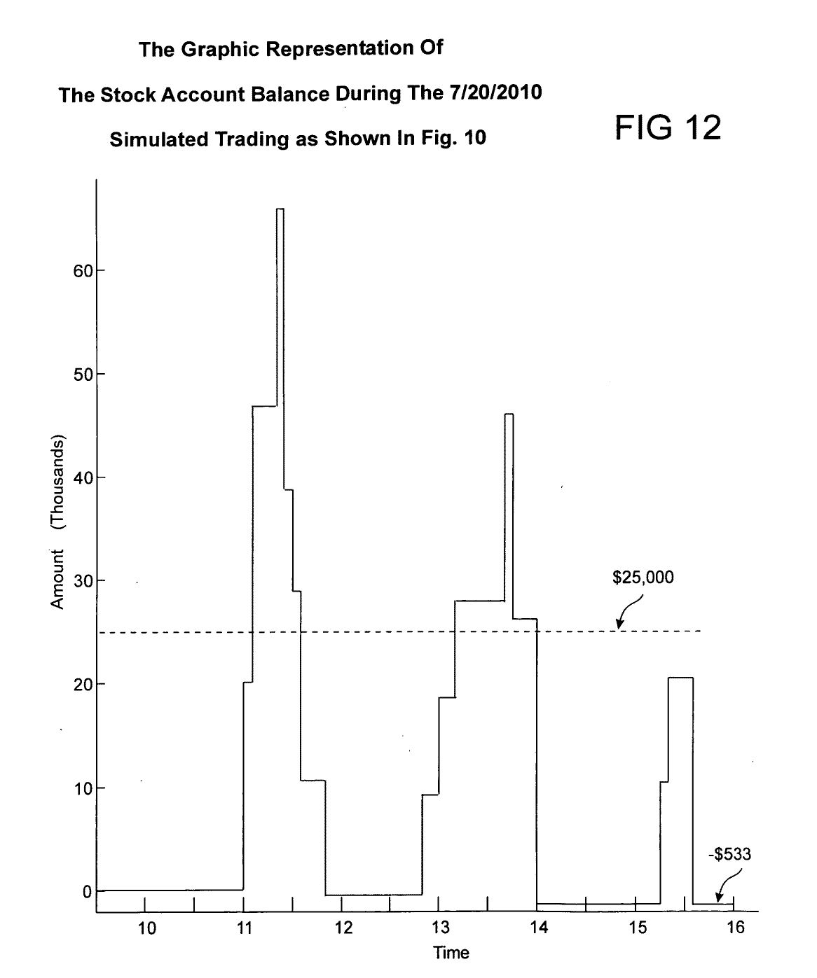

Since each up TBS comes with a strong momentum of rising price, the user may decide to place a buy trade for some of these stocks at a time near their up TBS time. This upward price momentum is especially true if the overall market is also in an upward trend. For the sake of discussion, it is assumed that this user places a buy trade during each of these fourteen stocks' up TBS time period. The result of these trades is shown in FIG. 10.

In each of the trades shown in FIG. 10, the entry time is assumed to be the close time of the 5 min bar following the TBS 5 min bar. The exit time is placed safely once the price shows some stagnation. But in a few cases the user decides to take a small risk to withstand one or two small red 5 min bars hoping for bigger gain afterward. The number of shares placed is to achieve a total of about $10,000 invested in each trade. It is seen that all but one trade are profitable.

FIG. 11 shows the stock account balance during the Jul. 20, 2010 simulated trading as shown in FIG. 10. FIG. 12 is a graphic representation of this same stock account balance shown in FIG. 11.

It is assumed that this stock account is freshly created on Jul. 20, 2010 with an initial balance of $0. For the present discussion, it is assumed that when a group of stocks is purchased by the trader, this group of stocks is placed in this stock account, and with the purchase price added to its account balance. When several stocks in this account are sold, these stocks must then be removed from this account, and with the selling price subtracted from the account balance. At the end of the day when all stocks in this account are sold, and the account balance becomes a negative number, this number is the profit gained by the trader, subject to the charge of the brokerage commission fee.

So the purpose of FIGS. 11 and 12, is to disclose the details of the flow of cash during this trading day. It points out in details the cash needed at different time by the trader in order to engage these trading during this trading day.

FIGS. 11 and 12 show that the maximum amount of cash needed by this trader in this trading day is $65,839, which is needed only for a period of 5 minutes. For a trader maintaining a cash balance of $25,000 in a brokerage firm, with a typical margin ratio of 4:1, or allowable cash for stock purchase of $100,000, all trading indicated in FIG. 10 are allowable.

In the Jul. 20, 2010 simulated trading, the trader achieved a profit of $533. By maintaining a cash balance of $25,000, it corresponds to a profit gain of 2.1% in a single day.

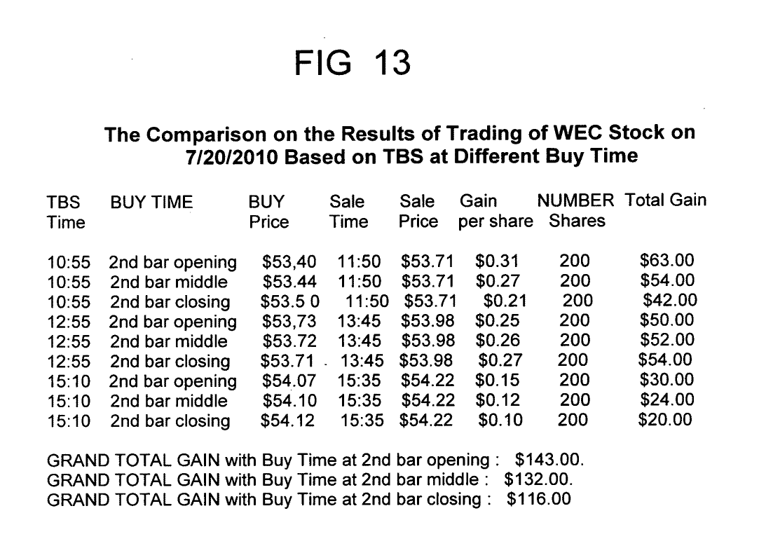

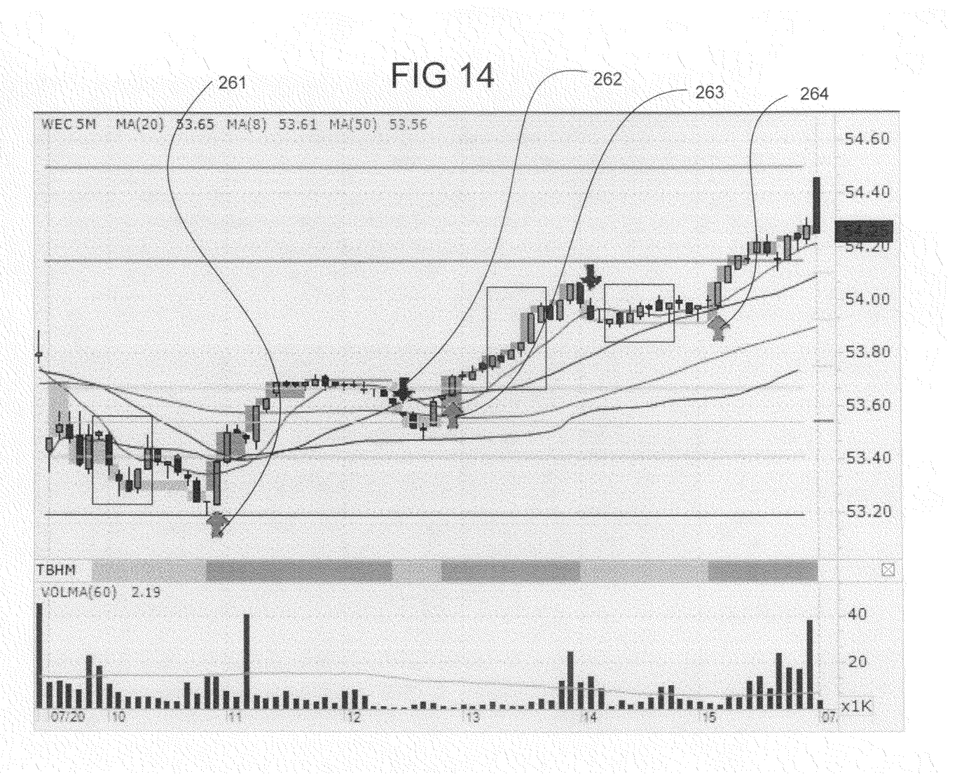

Presented in FIG. 13 is an in-depth analysis of the trading gain depending on the exact time of the trade entry. The stock WEC, the 5 min bar price chart of which is shown in FIG. 14, is chosen for the present analysis. A total of three up TBSs, 261, 263, and 264, are assigned by the RTS-PRO on this WEC price chart.

The user made three simulated trades on the WEC stock. The FIG. 13 shows the difference in the total gain if in each trade, the trade entry is not at the closing time of the 2nd 5 min bar, but instead at the opening or the middle of the 2nd 5 min bar. As shown in this figure, the total gain in these three trades would have been $143 with 2nd bar opening entry, or $130 with 2nd bar middle point entry, instead of $116 with 2nd bar closing entry.

It should be pointed out that all dollar amounts used in FIG. 13 are approximate numbers read from the price chart in FIG. 14, which is based on 5 min candlestick presentation. But the last prices reported on the list/filter sheet are probably cycle-specific without regard to the 5 min bar opening or closing price. A trader's entry of a trade is determined by the stock price listed by the brokerage firm, which may or may not be the same as the last price on the list/filter sheet at any given time.

The first advantage of the TBS list/filter sheet of the present invention as shown in FIGS. 7 to 9 is the inclusion of the TBS times in the TBS list/filter sheets. Once each TBS time with its stock symbol and TBS price are posted on the TBS list/filter sheet as part of the new data line, it will “peacefully” stay in this sheet without disappearance or any fluctuation, which is typically seen in other RTS list/filter sheets. No matter how long this sheet and the linked charts get, the user can go back to any posted stock and its chart by simply dragging up/down the curser in the sheet.

The second and most important advantage of the TBS list/filter sheet of the present invention is the availability of each TBS information, along with its associated stock price chart, to the user, typically within the first minute after its first appearance. As long as the overall market is in an upward trend, this TBS almost, but not always, assures a winning long trade potential. The profit will be larger the earlier the trade can be made, as demonstrated in the above example shown in FIG. 13. The same is true for a down TBS in a downward market trend.

In the present example, a list of only 8 utility stocks are checked for the appearance of the up TBS. In the existing RTO program the appearance of the TBSs are only shown in the stock charts, not in the list/filter sheet. If the user wants to monitor constantly a list of 300 stocks for the appearance of up TBSs, he must constantly watch all 300 stocks' charts on the screen, a practically impossible task.

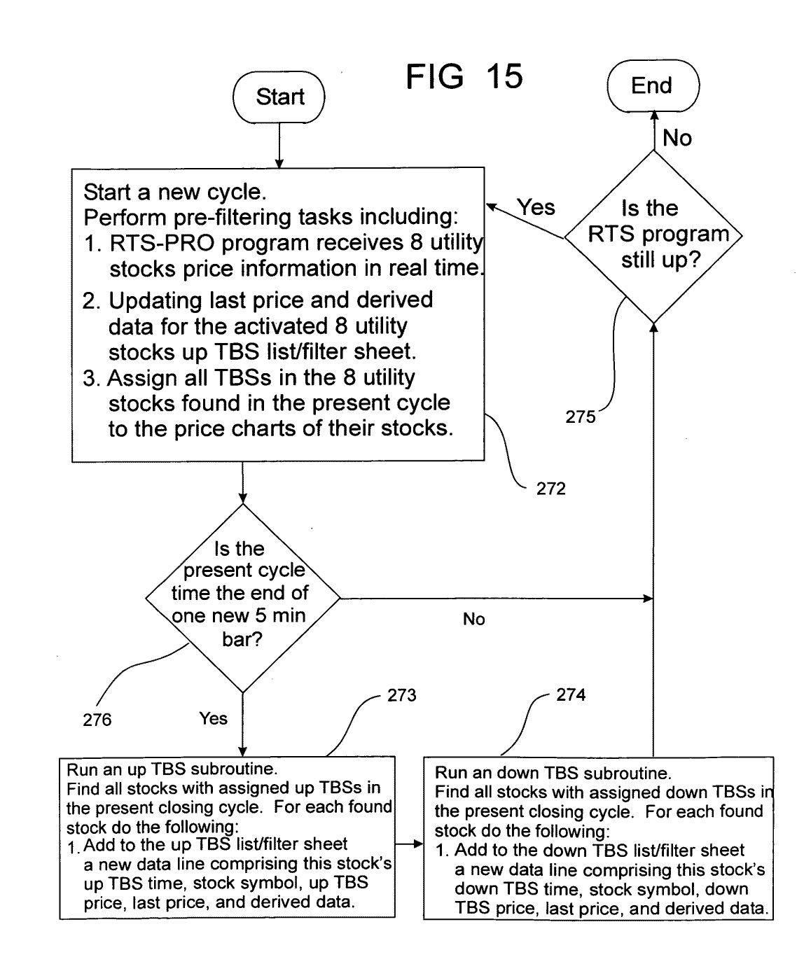

FIG. 15 is the flow diagram to be followed if the user creates two TBS list/filter sheets for processing both the up TBS and down TBS for filtering the selected eight utility stocks. In this flow diagram, the item 273 is a condensed version of the flow diagram shown in FIG. 6. The item 274 in FIG. 15 is basically the same as the item 273 except by replacing all “up” by “down”. As indicated by the item 276, the subroutines 273 and 274 are to be carried out when the cycle time is at the end of one new 5 min bar.

Filter B: TBS with Alerts

As discussed above, the profit will be mostly larger, the earlier this trade can be placed. In order to assure an earliest trade, the trader must be able to spot this TBS immediately after the pop up of this TBS. But the reality is that during a typical trading day, the user is very likely tied up with many activities and misses the appearance of the TBS until it is too late to act on this TBS. It would be very desirable to have some kind of alert(s) to immediately call the attention of the trader to this new TBS.

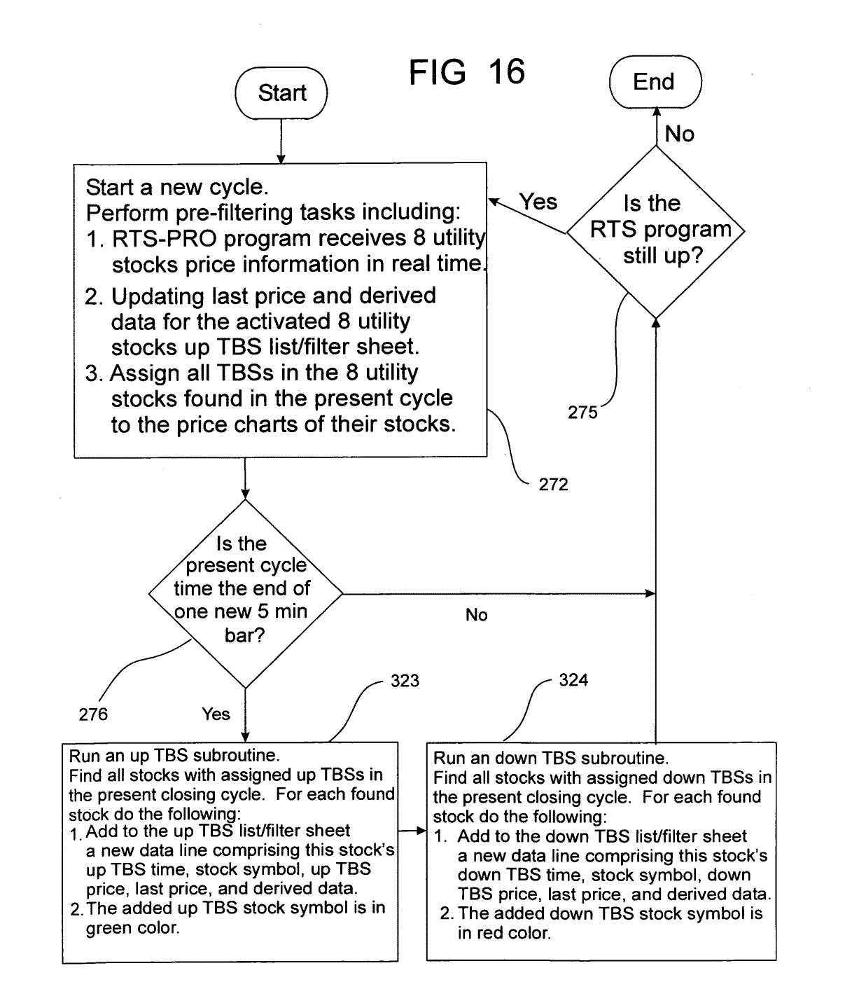

FIG. 5 discloses a filter B 45 for providing several alerts for calling the attention of the user on the appearance of each TBS. FIG. 16 shows a flow diagram for the filter B of the present invention. This flow diagram is essentially the same as the flow diagram shown in FIG. 15, except by adding the words including “in green color” in the item 323, and the words including “in red color” in the item 324. The result are that all stock symbols entered in the up TBS list/filter sheet will appear in green color, and all stock symbols entered in the down TBS list/filter sheet will appear in red color.

In the existing RTS-PRO program, all entered words in its list/filter sheets are in black color. Now with this filter B, all entered stock symbols will appear in either green or red. Such a sharp change of color will very likely call the attention of the trader immediately for an early trade decision. If desired, this color alert can stay for 5 or 10 minutes, after which time the color of these entered stock symbols can return to black, because the golden opportunity for trade entry is probably already gone by then. This may guide the user for attention to other more new TBSs.

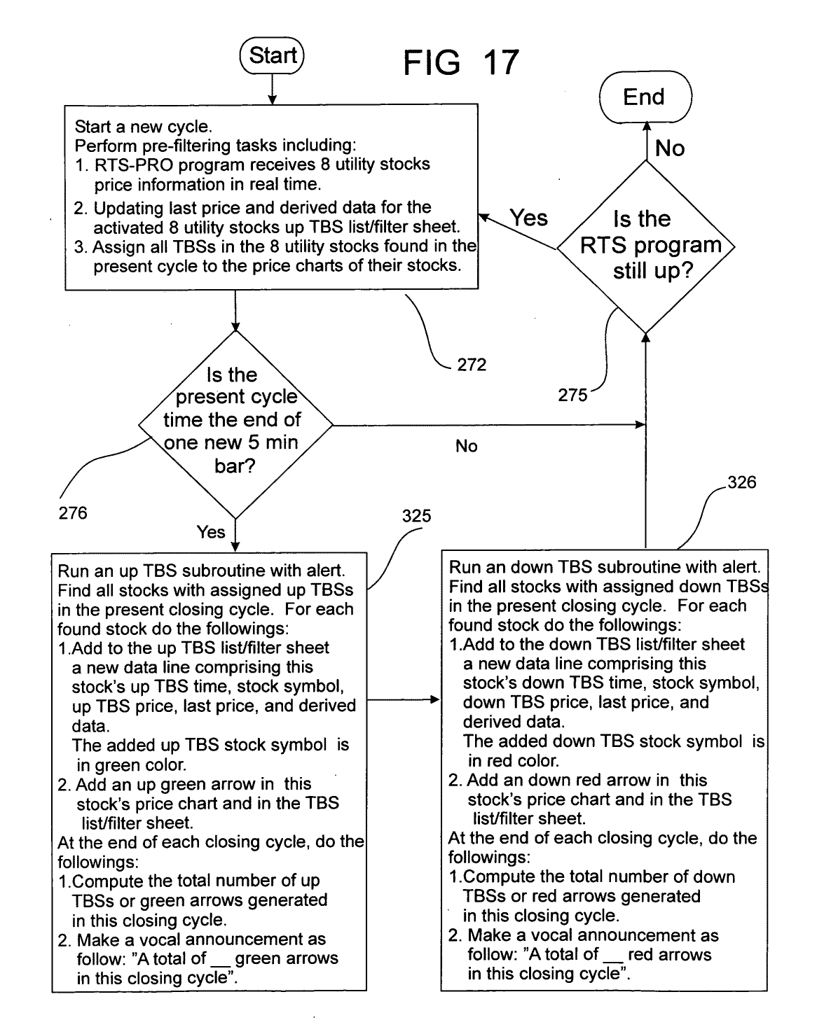

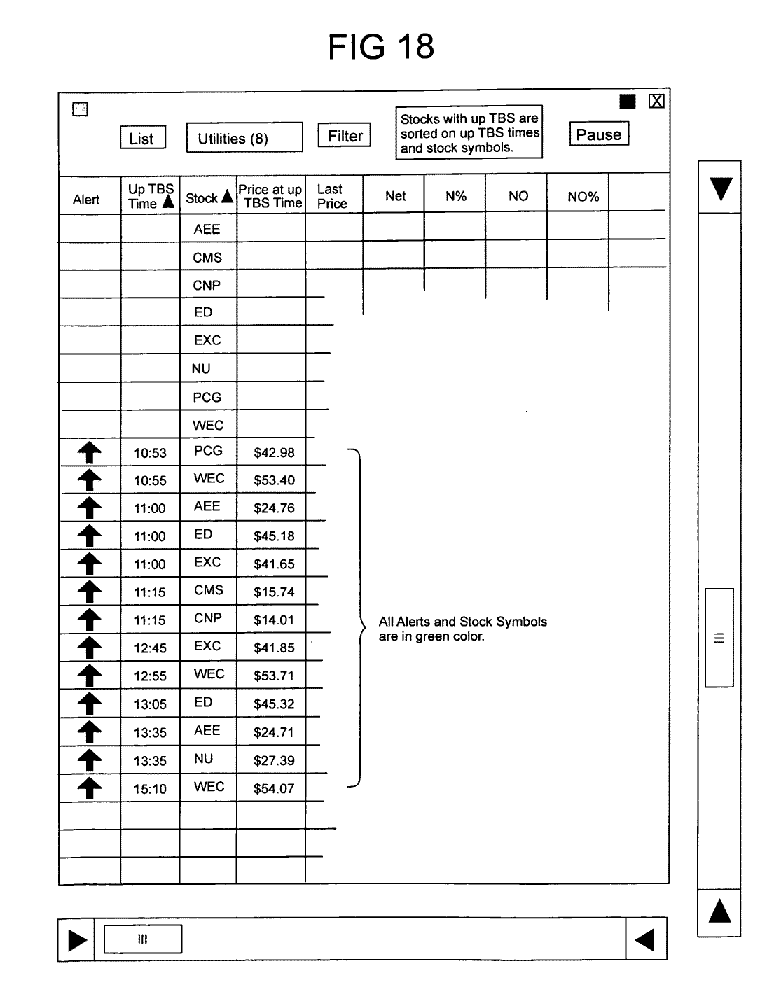

FIG. 17 shows another flow diagram for the filter B of the present invention, which adds several new alerting features for calling the attention of a user on the appearance of an up/down TBS. FIG. 18 shows one TBS list/filter sheet illustrating several alerts by implementing the filter B based on the flow diagrams of FIGS. 16 and 17.

The TBS list/filter sheet shown in FIG. 18 is displayed shortly after 15:10 EST in filtering the eight utility stocks. This is the moment an assigned up TBS was just found for the stock WEC. Compared with the TBS list/filter sheets shown in FIGS. 7-9, the present TBS list/filter sheet in FIG. 18 has a new alert column added next to the up TBS time column. It is seen here that for each found up TBS, an up green arrow is placed in this alert column to alert the user on the appearance of this up TBS.

It is suggested that each up green arrow be flashing for 5 or 10 minutes when it first appears. It will make this new up green arrow to stand out compared with other earlier steady green up arrows, and further warn the user on the urgency of this new TBS.

One other new alert feature explained in the flow diagram in FIG. 17 is the vocal alert “A total of ______ green arrows in this closing cycle.” Sometimes the critical TBS list/filter sheet is hiding behind other sheets and not visible. In this case, this vocal alert will become the only alert available for calling the attention of the user.

All the above discussion on up TBS alerts are equally applicable to the down TBS alerts, as explained in the flow diagram shown in FIG. 17, item 326. In the present discussion on the filters A and B, only 5 min bars are considered. But bars with other duration should also be considered. For example, the filter A for filtering 1 min bar chart may yield even earlier assigned TBS for the entry of the stock. It also may show the earlier sign of price stagnation for alerting the trader of the trade exit. Same is true for all filters discussed below.

### Filter C: Closing Price—Closing Price

A new filter C 56 is shown in FIG. 5 for filtering a stock list in finding stocks each having a 5 min bar with its closing price either higher or lower than the closing prices of last two or three bars. The appearance of such bar may point out the rising or falling price trend of stock, suitable for trade entry. This is especially true when it is reinforced by other favorable indicators such as the overall market trend and VWAP.

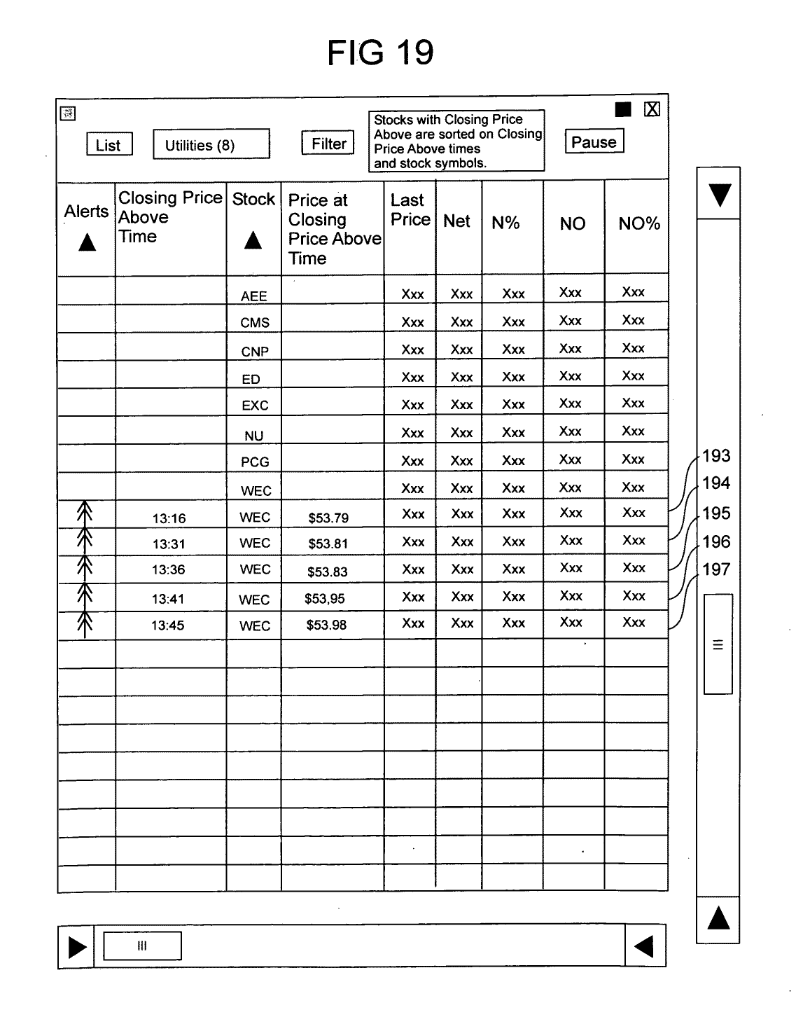

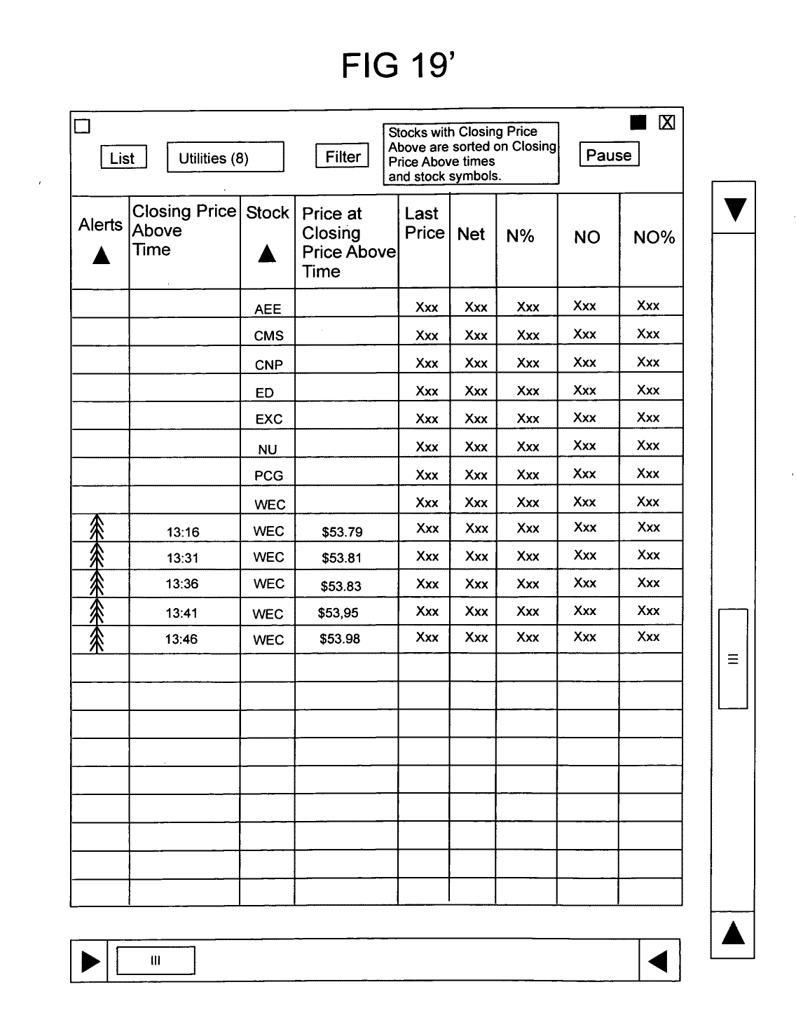

After clicking the filter C box 56, the user can select closing price either above or below the closing prices of several prior 5 min bars. After the above selection, the user must then decide whether the prior two or three 5 min bars are selected. After the above selections, a closing price-closing price list/filter sheet will be created as shown in FIG. 19. In this sheet, the list of stocks to be used is the eight utility stocks. Before the processing of the filter C, only the first eight lines of data showing the symbols of these eight utility stocks as well as their last prices and derived data will be displayed in this sheet.

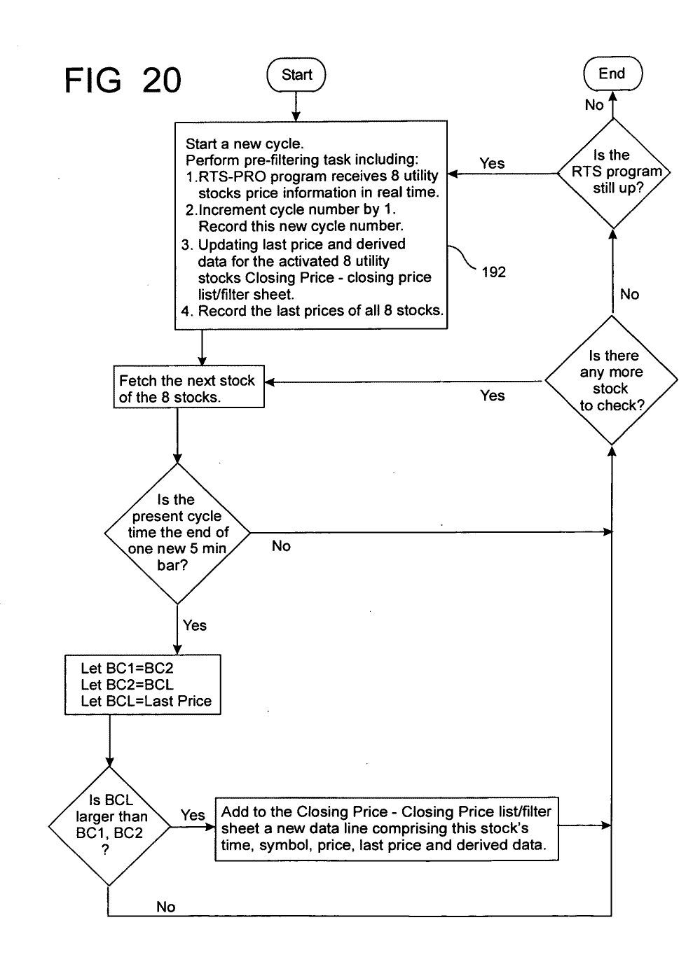

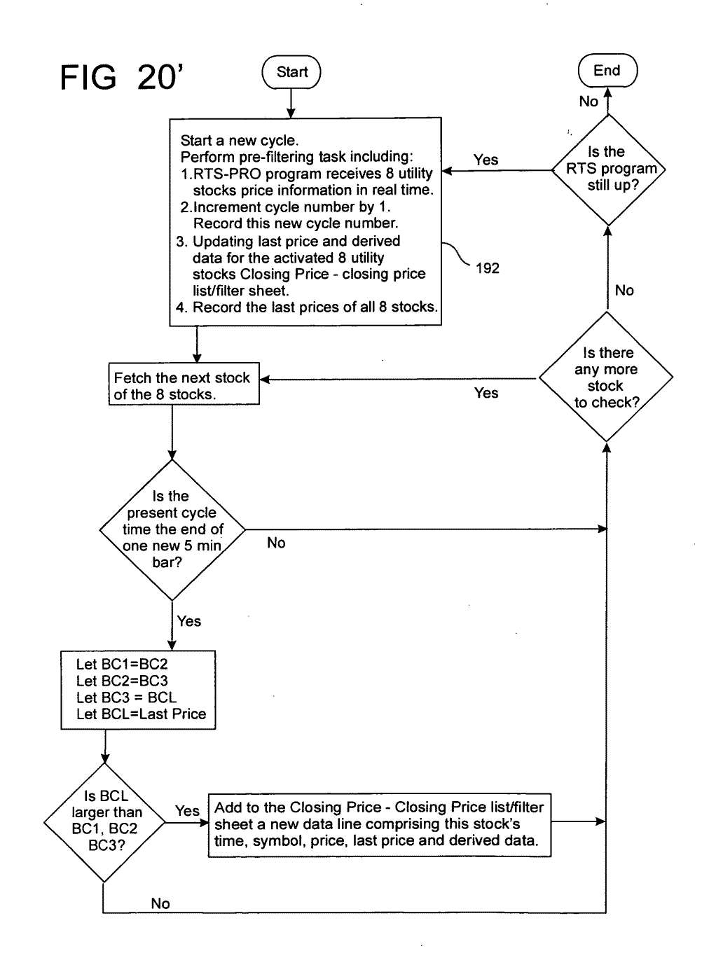

FIG. 20 shows a flow diagram for the filter C of the present invention. This particular filter C is for filtering the eight utility stocks in finding stocks each having a 5 min bar with its closing price higher than the closing prices of prior two 5 min bars. As seen in FIG. 20, this filter is operated in cycles, with each cycle lasting a fraction of a second or several seconds, depending on the number of stocks in the list, and the filtering load. During each cycle, both the pre-filtering task as listed in the item 192 in FIG. 20, and the actual filtering task will be carried out. Most of the pre-filtering task is part of the existing RTO program and can be carried out with or without the present filter invention.

For each 5 min bar, the filter C needs to find out from the pre-filtering task the time and cycles that defines this 5 min bar, as well as the closing price for this 5 min bar. This filtering is to compare the closing price of this 5 min bar and the closing prices of two immediate prior 5 min bars, termed “prior bar”, which is the bar immediately prior to the current bar, and “prior prior bar”, which is the bar immediately prior to the prior bar.

The central filtering task for each 5 min bar is to find out whether the closing price of the bar, termed “BCL”, is higher than the closing price of the prior bar, termed “BC2”, and the closing price of the prior prior bar, termed “BC1”. If the answer is yes, the symbol of this stock, as well as the closing price and time of this 5 min bar, will be placed in the closing price—closing price list/filter sheet. Several alerts, introduced in the prior discussion, can also be placed here to alert the user for the possible trade entry consideration.

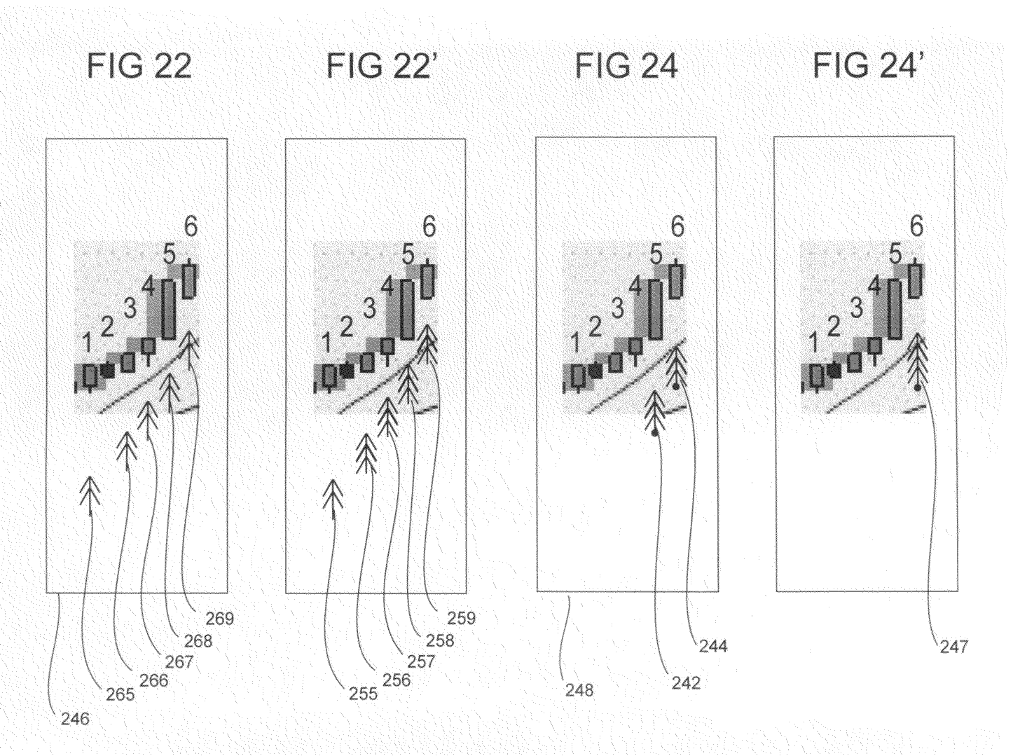

For the purpose of explanation of this filter C, the stock WEC, the chart of which has been shown in FIG. 14, will be used to demonstrate the processing of this filter. A section of this chart, enlarged as shown in FIG. 22, consisting of six 5 min bars, numbered from 1 to 6, covering a time period from 13:16 EST to 13:46 EST, and enclosed in a box 246, will be chosen for the present demonstration.

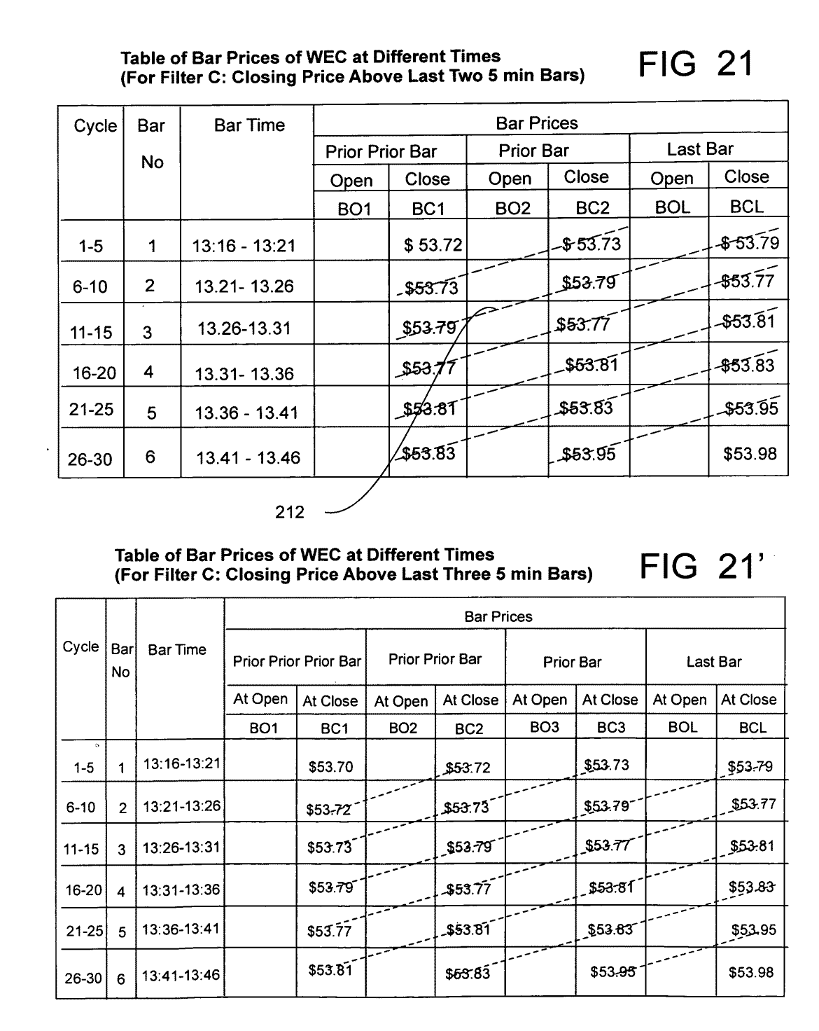

The present processing of the filter C is also tabulated as shown in FIG. 21. It is assumed that five cycles at 1 min/cycle constitute each 5 min bar. As seen in FIG. 21, the first cycle, named cycle 1, for the present demonstration, is assigned for the actual cycle during 13:16 EST that day.

As shown in FIG. 20, after the pre-filtering task as represented by the item 192, the eight utility stocks will be fetched, one by one, during this first cycle for the filter C processing. But nothing is to be done because this cycle time is at the start or opening of the 5 min bar #1. Also nothing will be done during the next three cycles, because they are at middle of the 5 min bar #1.

During the next cycle, i.e., cycle 5, this cycle time is the end of the 5 min bar #1. According to FIG. 20 flow diagram, the following processing will be carried out:

Let BC1 (of bar #1)=BC2 (of the bar prior to the bar #1)

Let BC2 (of bar #1)=BCL (of the bar prior to the bar #1)

Let BCL (of bar #1)=last price (just recorded in this cycle as done in item 192)

During the cycles 10, 15, etc., the above processing will also be carried out. This will assure that for each 5 min bar, not only the closing price of this bar will be recorded; the closing prices of the two preceding 5 min bars will also be recorded as shown in FIG. 21.

The assignment of BC1 and BC2 for each 5 min bar may also be obtained right on the FIG. 21 table. One may draw a first diagonal line 212 connecting the following blocks at (Bar #3, BC1), (Bar #2, BC2), and (Bar #1, BCL). One can next draw the second, third, diagonal lines below and in parallel with the first diagonal line 212 for connecting the next three blocks in sequence. All three numbers in these three blocks linked by one diagonal line must be identical. This is the way to obtain the BC1 and BC2 data for one 5 min bar from the previous 5 min bar. The BCL block in each 5 min bar is the last price or closing price of this 5 min bar obtained fresh from the task carried out in the item 192 in FIG. 20.

As seen in FIG. 20, at the end of each 5 min bar, the following question will be asked, “Is BCL larger than BC1, BC2?” If the answer is yes, a new data line will be added as demonstrated below.

The first time the BCL was found higher than BC1 and BC2 was during the cycle 5, the ending cycle for the #1 bar. As seen in FIG. 21, the last price of WEC obtained at this cycle is $53.79, which is higher than BC1 ($53.72) and BC2 ($53.73). As instructed in FIG. 20, this modified RTS program will add a new data line 193 comprising #1 bar's closing price above time, stock symbol, and price at closing price above, last price and derived data to the closing price-closing price list/filter sheet shown in FIG. 19.

With further processing of the filter C, the closing prices of the 5 min bars #3, #4, #5, and #6 are each found to be higher than the closing prices of its two prior 5 min bars. Four new data lines 194, 195, 196, 197 for these four 5 min bars are also added to the closing price-closing price list/filter sheet as seen in FIG. 19.

In FIG. 19, all new data lines 193, 194, 195, 196, and 197, once created, will stay in the list/filter sheet throughout the rest of the stock session. The last price and derived data will be updated continuously, but the closing price above time and price at closing price above time will stay unchanged.

As seen in FIG. 22, five up green arrows 265, 266, 267, 268, and 269 are placed below the 5 min bars #1, 3, 4, 5, and 6, respectively. Each arrow has two “up wings”, which can be interpreted as sign for a closing price above the closing prices of two prior 5 min bars.

It is also seen in FIG. 19 that there are five up green arrows displayed in the Alert column of the closing price-closing price list/filter sheet. These alerts, as well as the flashing and vocal announcement alerts may be enough to convince the trader to enter a long trade this time.

A brief description can be offered here for a user choosing a filter C for finding stocks each with a 5 min bar having a closing price above the closing price of three prior 5 min bars. FIGS. 19′, 20′, 21′, and 22′ are shown replacing FIGS. 19, 20, 21, and 22, respectively. The tasks required to assign each 5 min bar with its closing price, 5 min bar time and cycle number are the same for these two filters. But the additional task of recording the closing prices of these three prior 5 min bars will be needed. After this, a question “Is BCL larger than BC1, BC2, and BC3?” will be answered to find out the filtered 5 min bar.

In FIG. 22′, five up green arrows 255, 256, 257, 258, and 259 appear, just as many as five up green arrows seen in FIG. 22. Each this arrow has three “up wings”, which can be interpreted as sign for a closing price above the closing price of three prior 5 min bars. These same five up green arrows are also seen in FIG. 19′, and accompanied by all associated alerts features for calling the attention of the trader.

Clearly, the criteria for above three prior bars are more stringent than just above two prior bars. Fewer candidates will be found, but each find may provide a higher potential for profitable entry.

The use of the filter C for filtering all stocks each with its 5 min bar closing price lower than two or three prior 5 min bars closing prices are also available as seen in FIG. 5. The process of these filtering is basically the same as the first two filters just described, except that all words of “higher”, “up”, “green”, “bullish”, “larger”, “above”, must now be replaced by the words “lower”, “down”, “red”, “bearish”, “smaller”, and “below”, respectively. The up green alert arrow with two or three up wings will also be replaced by the down red alert arrow with two or three down wings.

The concept of filter C of the present invention can be further expanded for filtering stocks each having its 5 min bar with its closing price higher or lower than the closing prices of four or more prior 5 min bars. In these cases, the assignment of all 5 min bars remains unchanged. Recording of more prior 5 min bars will be needed. After this, relevant comparison between the current 5 min bar with all needed prior 5 min bars will be made to find out the filtered 5 min bars.

### Filter D: Consecutive Bars

A new filter D 58 is shown in FIG. 5 for finding stocks in a list that each has three or four consecutive rising green or falling red 5 min bars. Such a continuously rising or falling price in a stock may present a trend and suggest a favorable chance for trade entry.

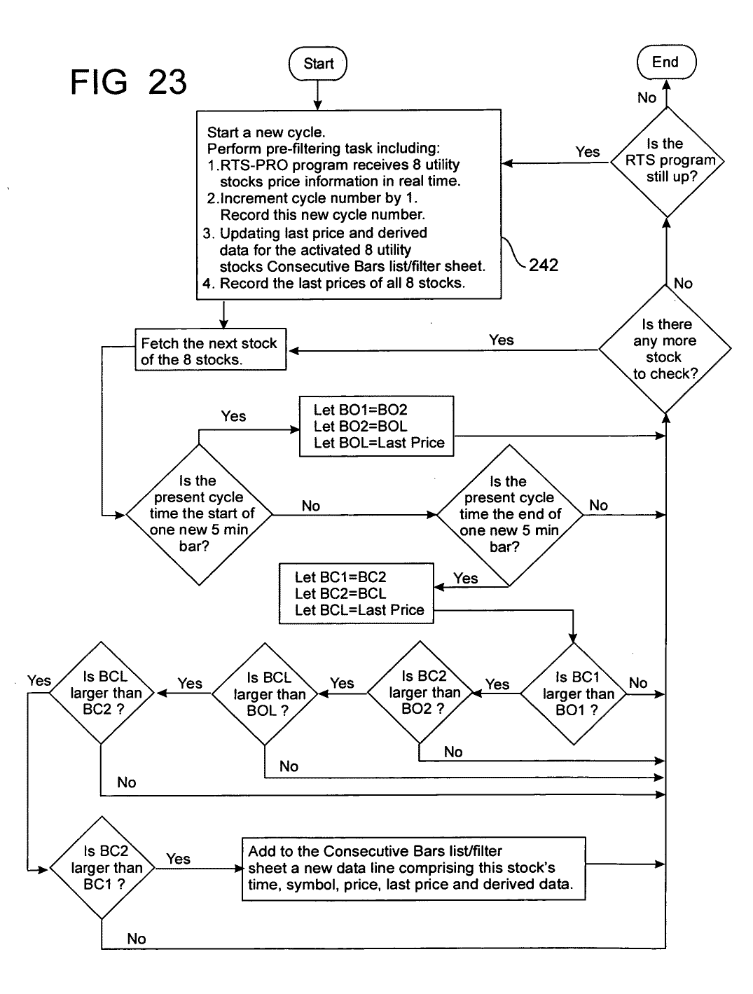

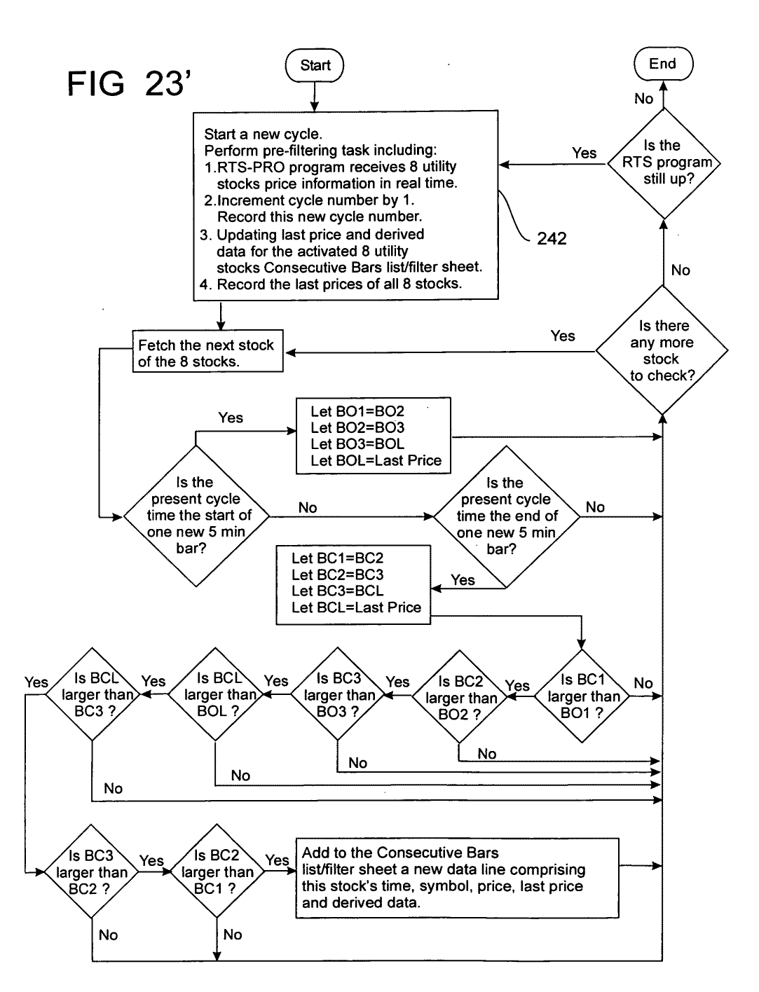

After clicking the filter D box, the user must make two selections; the first one between three consecutive and four consecutive, the second one between rising green and falling red 5 min bars. FIG. 23 shows a flow diagram of the filter D of the present invention for filtering for three consecutive rising green 5 min bars. Just like FIG. 20, at the start of each cycle, several pre-filtering tasks will be performed as outlined in the item 242 in FIG. 23.

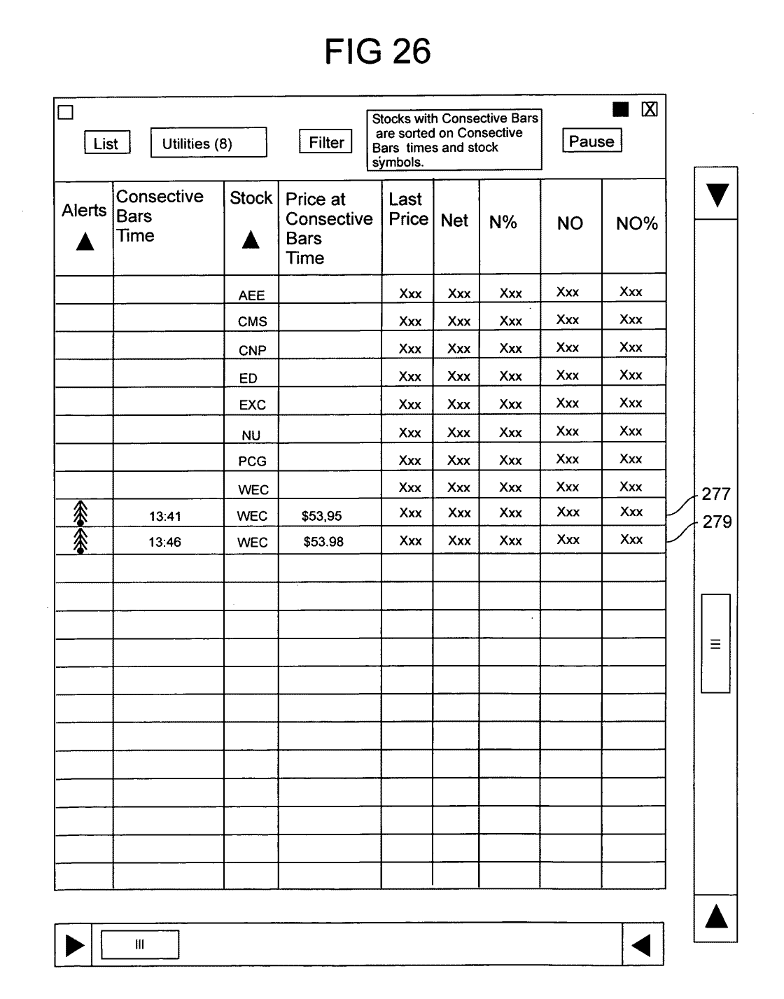

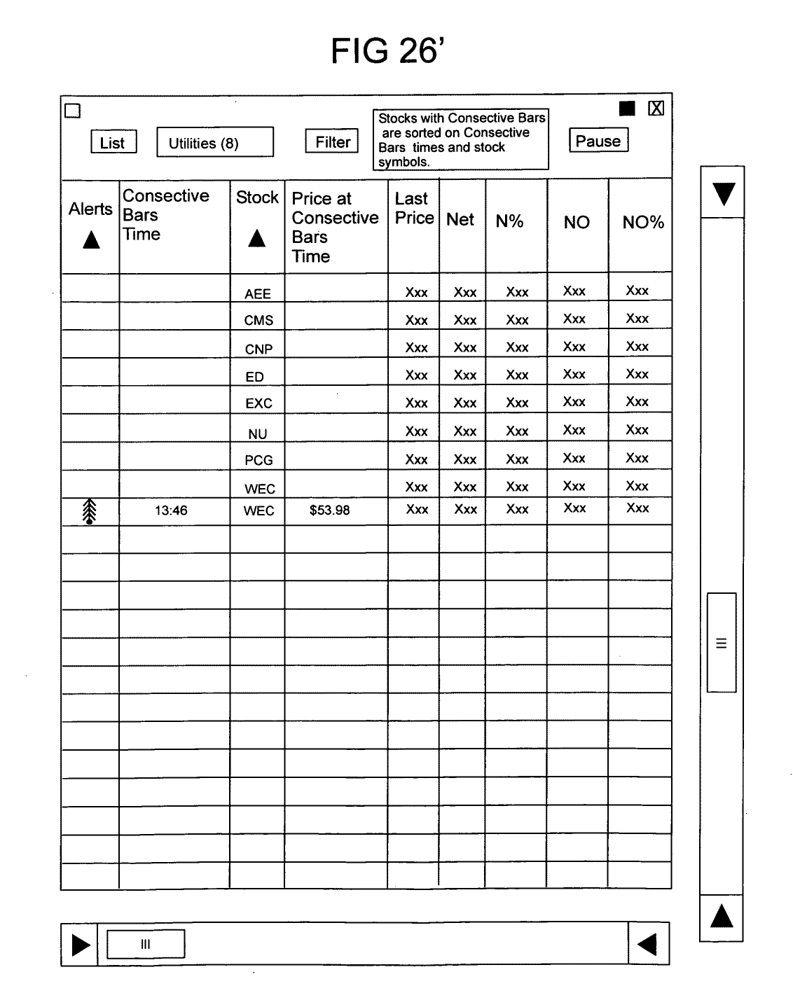

Right after the selection of such filter D, a three consecutive bars list/filter sheet is created as shown in FIG. 26. Again a list of eight utility stocks is used in the present example. The same section of the stock WEC, presented in the previous discussion and shown in FIG. 22, is used again in the present demonstration, except that this section is now shown in FIG. 24. The same six 5 min bars, also numbered from 1 to 6, are enclosed in a box 248.

Similar to the case of filter C, in the first job of the filtering task in the present filter D is to extract real time price data from the pre-filtering item 242 to define each created 5 min bar. These data include the time and cycles, as well as opening and closing prices of each created 5 min bar. The opening (BO1, BO2) and closing (BC1, BC2) prices of two preceding 5 min bars will also be derived as part of this filtering task.

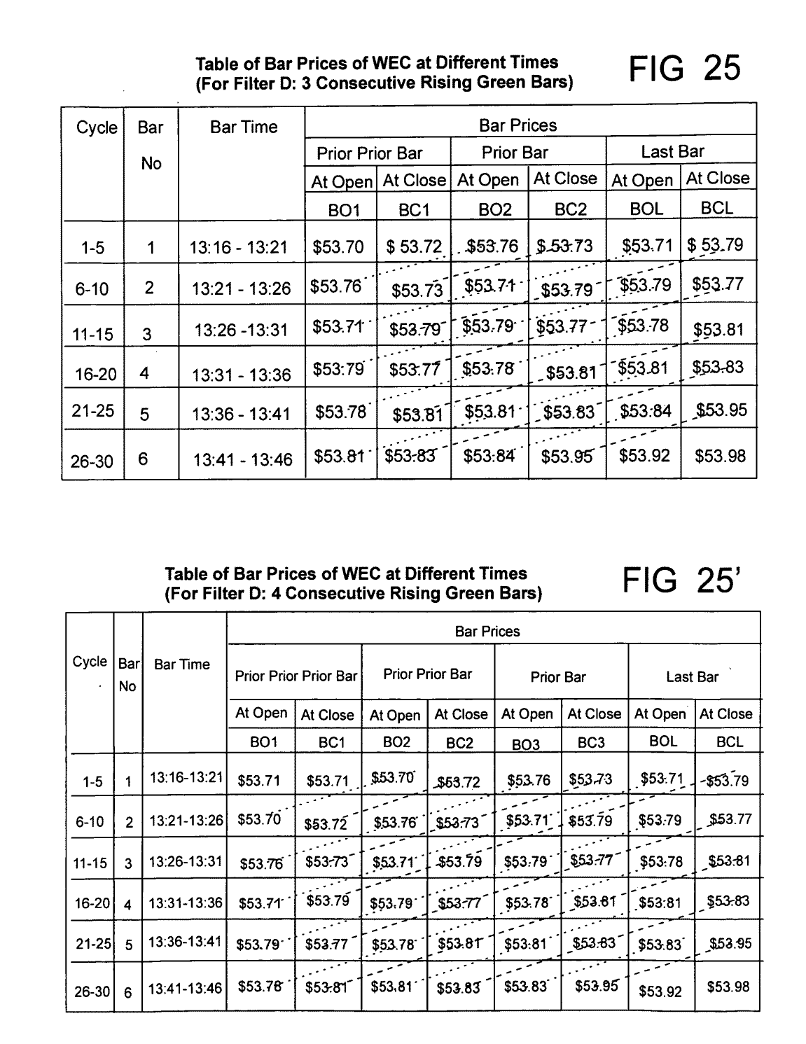

FIG. 25 is a table of 5 min bar prices of WEC for the present filter D. It is essentially the same as the table shown in FIG. 21, except that the opening prices of each 5 min bar (BOL) and its preceding two 5 min bars (BO1 and BO2) are also included. The method for obtaining these data is shown in the flow diagram in FIG. 23. The diagonal lines described in the previous section can also be drawn similarly to obtain the BO1 and BO2 information for each new 5 min bar.

As shown in FIG. 23, the criteria for finding three consecutive rising green 5 min bars are as follow:

BC1>BO1

BC2>BO2

BCL>BOL

BCL>BC2

BC2>BC1

The first three lines decide whether all these three 5 min bars are green bars. The next two lines decide whether these three 5 min bars are rising consecutively in their closing prices.

Prior to the start of the filtering, the consecutive bars list/filter sheet only displays the eight utility stocks, along with their last prices and derived data. At cycle 25 of the filtering, which is 13:41 EST time that day, all above listed five criteria for three consecutive rising green 5 min bars are met. This fact is also confirmed by viewing the FIG. 24 chart showing three rising green bars #3, #4, and #5, as well as the values of B01, BC1, B02, BC2, BOL, and BCL on the line of the bar #5 of FIG. 25. As indicated in the flow diagram of FIG. 23, the modified RTS program will add the WEC stock with its consecutive bars time of 13:41, stock symbol WEC, the consecutive bar price of $53.95, last price, and derived data to the FIG. 26 consecutive bars list/filter sheet as a new data line 277 just below the eight utility stocks lines.

With further processing of the filter D, a second three consecutive rising green 5 min bars was found at the closing time of the 5 min bar #6. This fact is also confirmed by viewing the FIG. 24 chart and the FIG. 25 table. A second WEC new data line 279 is placed in the consecutive bars list/filter sheet of FIG. 26. It is interesting to note that the present 5 min bars string is more than a three consecutive rising green 5 min bars, but rather a four consecutive rising green 5 min bars, as shown in FIG. 24.

As shown in FIG. 24, two up green arrows 242 and 244 are placed below the 5 min bars #5 and #6. Each of these arrows has three “up wings”, which can be interpreted as sign for three consecutive rising green 5 min bars.

Two similar up green arrows are also placed in the list/filter sheet of FIG. 26 in the alert column. These green up arrows alert, as well as the flashing and the vocal announcement alerts, may also convince the trader to enter a long trade during this time.

A brief description can be offered here for user choosing a filter D for finding four consecutive rising green 5 min bars in all stocks in the list. FIGS. 23′, 24′, 25′, and 26′ are shown replacing FIGS. 23, 24, 25, and 26, respectively. The difference between these two filters is clearly shown in their flow diagrams in FIGS. 23 and 23′.

At 13:46 EST that day, the filtering of the WEC stock discovered a four consecutive rising green 5 min bars string. As instructed in the FIG. 23′ flow diagram, a similar group of data are added to the consecutive bars list/filter sheet as shown in FIG. 26′. A new green up arrow 247 is shown placed below the 5 min bar #6 in FIG. 24′ and in the alert column in FIG. 26′. This arrow has four “up wings”, which can be interpreted as sign for four consecutive rising green 5 min bars.

The use of the filter D for filtering all stocks each with three or four consecutive falling red 5 min bars are also available as seen in FIG. 5. The concept of filter D of the present invention can also be expanded for filtering stocks each with five or more consecutive rising green or falling red 5 min bars.

### Filter E: Closing Price-Bar

In the list/filter panel 20 of FIG. 2 a filter “Above or Below First ______×5 min bars” is shown. This filter is provided for filtering a list of stocks for finding stocks each with a 5 min bar having its closing price higher or lower than the first ______ 5 min bars. It is intended to find a new high or new low of the day for a stock, a promising candidate for trade consideration. This filter is ill designed, because for finding a new high or new low for the day, the correct filter should be “higher/lower than all prior 5 min bars”, or more specifically “higher/lower than all prior prices”.

So this filter listed in the panel 20 should be interpreted as a filter for finding stocks each with its closing price higher or lower than the price in the first ______×5 min bars since the opening of the trade of the day. But such a 15 or 30 min opening high or low is no longer relevant for the market already opened for one or more hours. It is the price in the immediate past 15 or 30 min should be of concern for judging the current price trend.

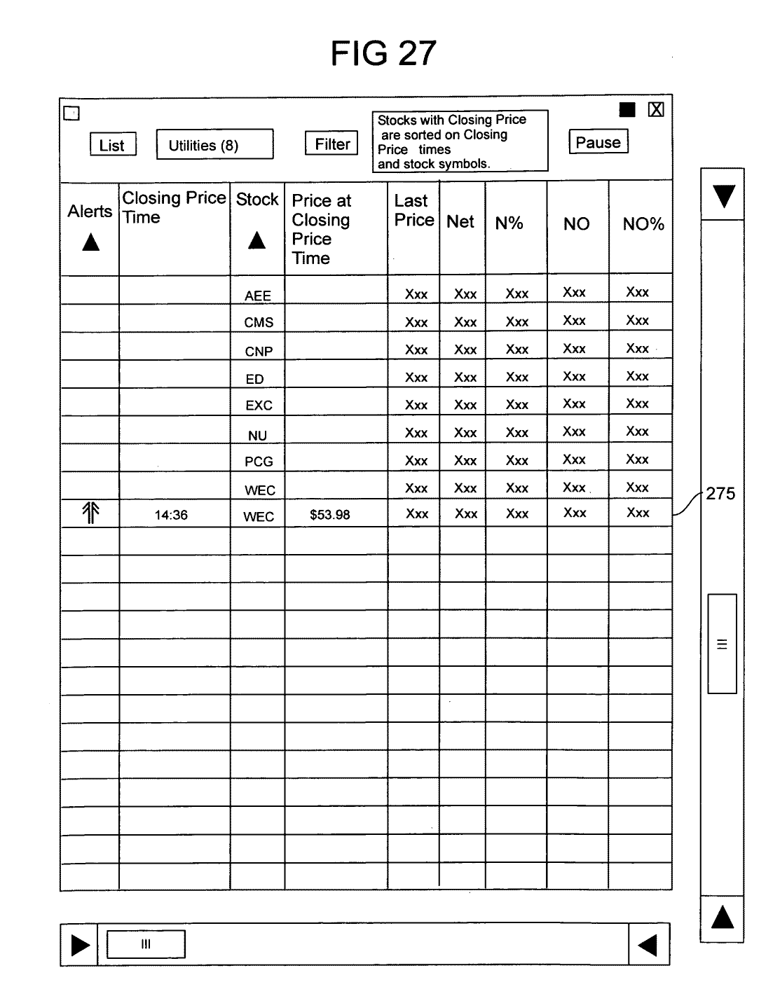

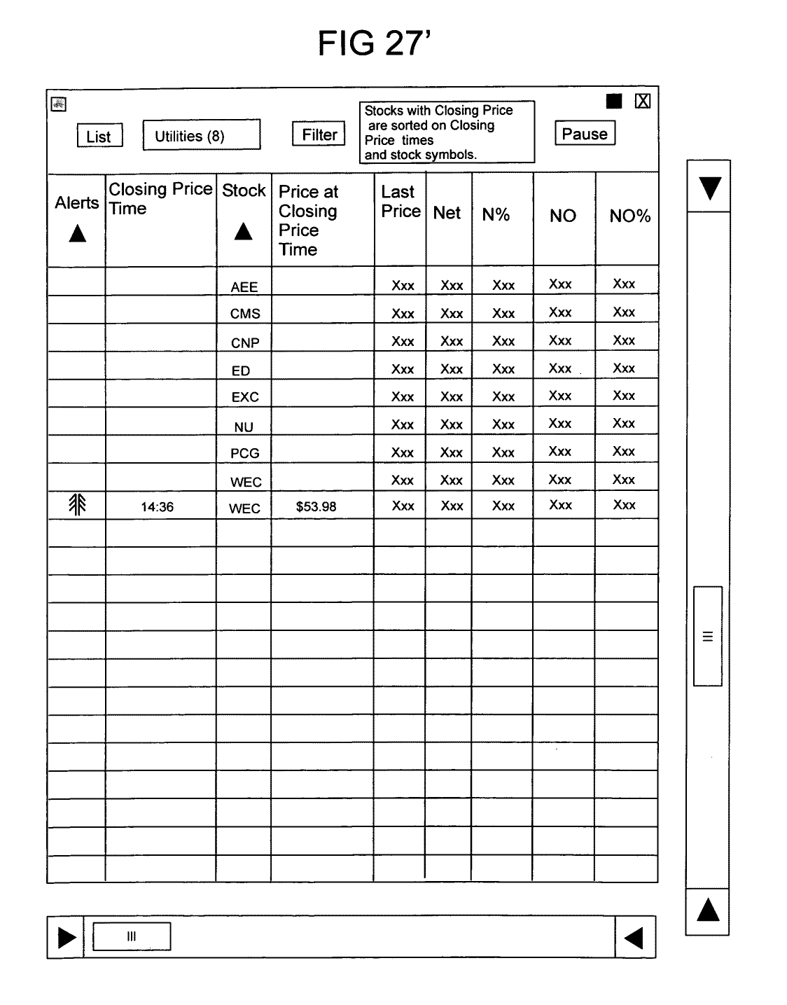

A new filter E 57 is shown in FIG. 5 for filtering a list of stocks in finding stocks each having a 5 min bar with its closing price above or below two or three prior 5 min bars. For the purpose of illustration, it is assumed that after clicking the filter E box, the user chooses to have a filter E for finding stocks each having a 5 min bar with its closing price above prior two 5 min bars. The list of stocks chosen is also the eight utility stocks in the trading day of Jul. 20, 2010. FIG. 27 shows a closing price-bar list/filter sheet, which will only list the eight lines of these eight stocks prior to the filtering activity.

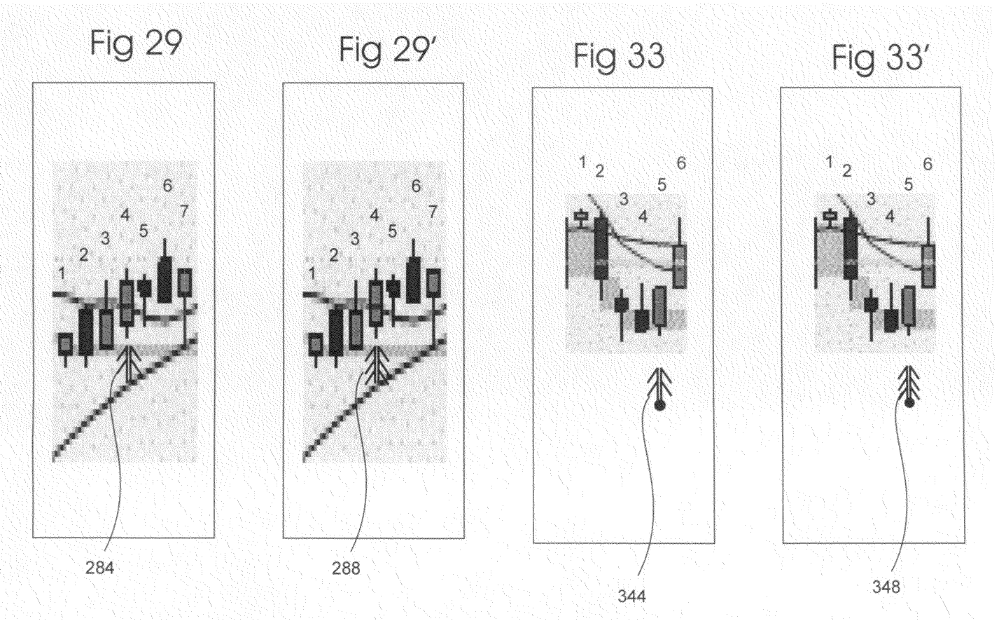

For the purpose of explanation of this filter E, the stock WEC, the chart of which has been shown in FIG. 14, will be used to demonstrate the processing of this filter. A section of this chart, enlarged as shown in FIG. 29, consisting of seven 5 min bars, numbered from 1 to 7, covering a time period from 14:16 EST to 14:51 EST, will be chosen for the present demonstration.

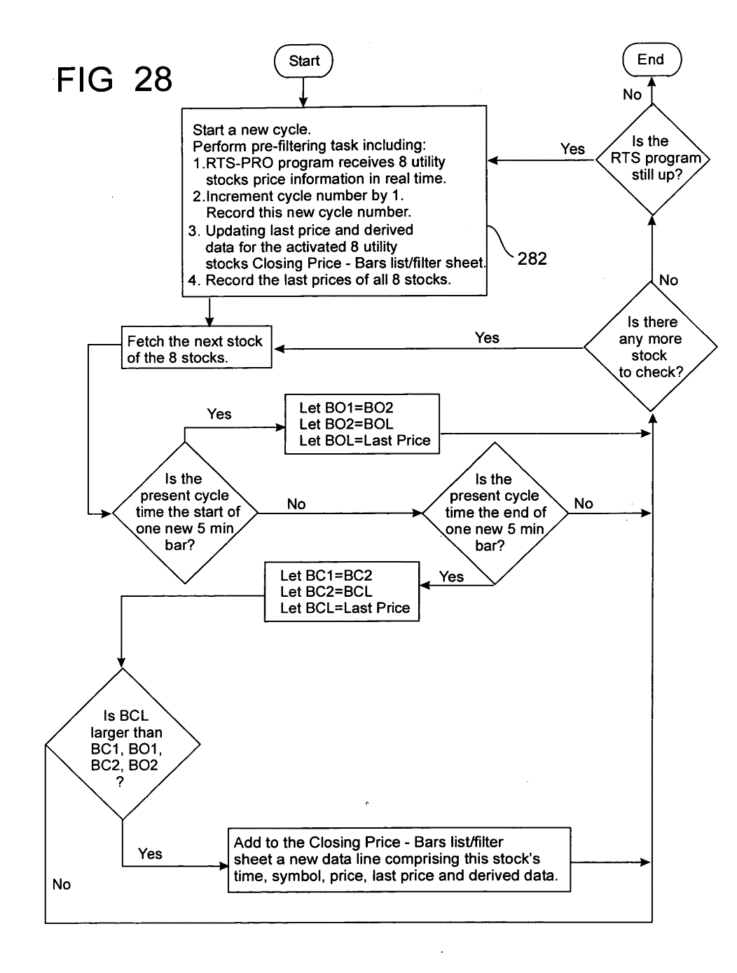

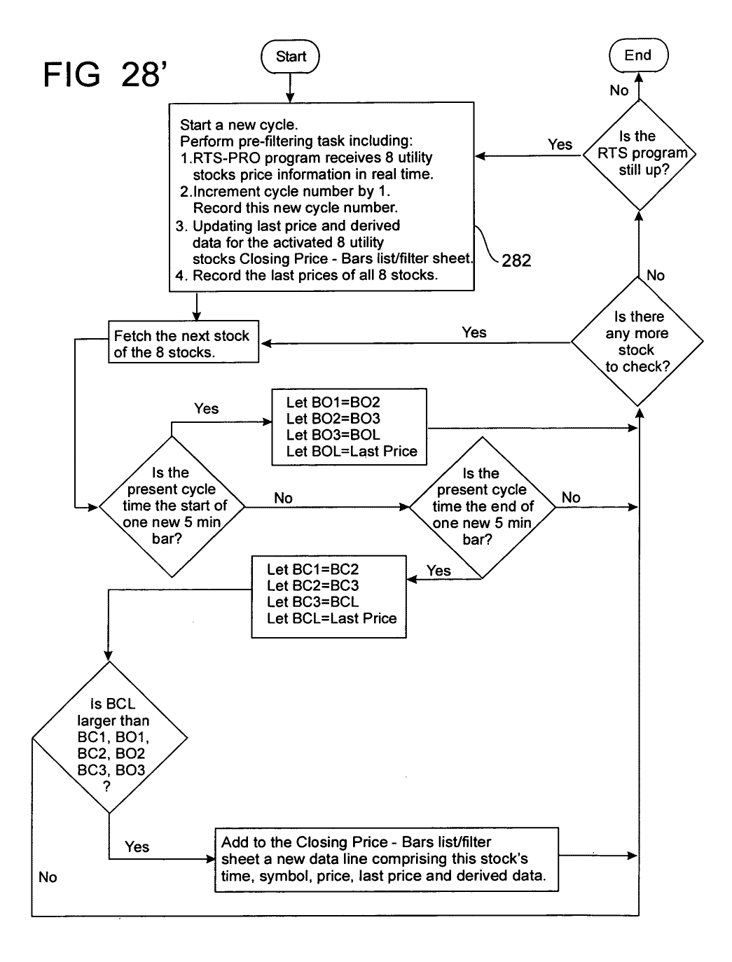

FIG. 28 shows a flow diagram for the chosen filter E of the present invention. Just like FIG. 23, at the start of each cycle, several pre-filtering tasks will be performed as outlined in the item 282 in FIG. 28. The first task in the filtering for assigning each 5 min bar with its opening and closing prices, as well as that of the prior two 5 min bars, is also the same as that disclosed in FIG. 23.

As outlined in FIG. 28, the only question to be asked by the present filter E is

“Is BCL larger than BC1, BO1, BC2, and BO2?”

With each yes answer, the modified RTS program will add a new data line comprising the stock closing time, stock symbol, closing price, last price and derived data to the closing price-bars list/filter sheet.

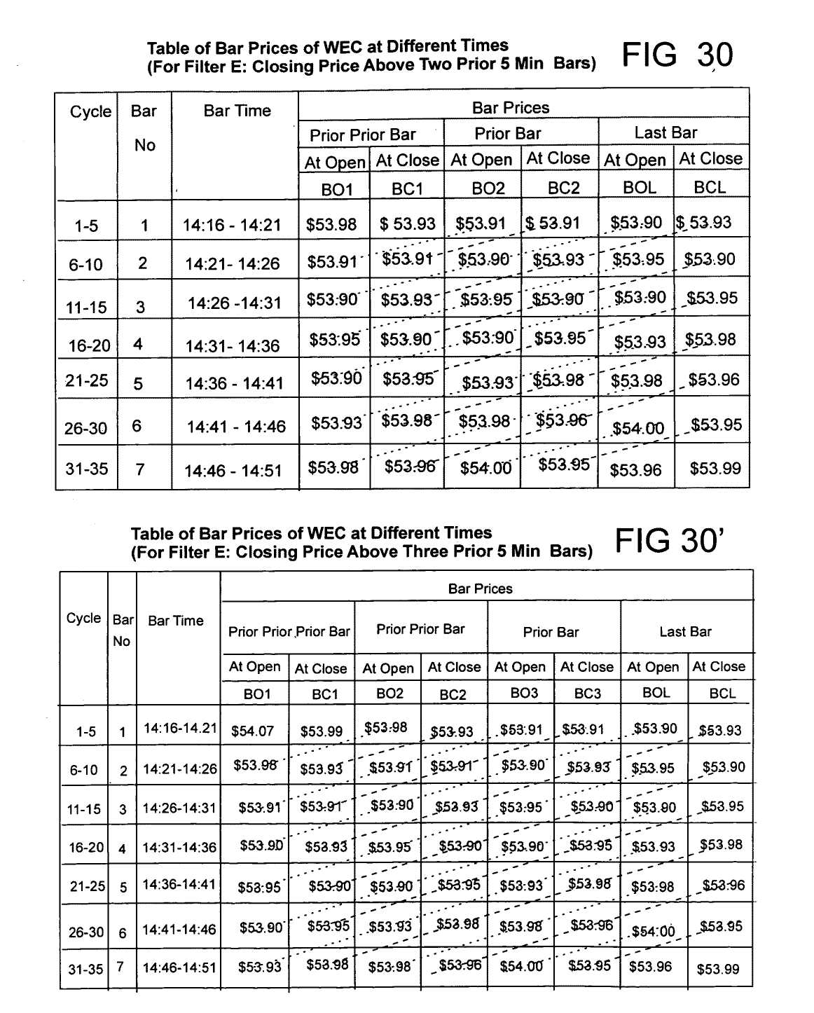

FIG. 30 lists the tabulated data for each of the seven 5 min bars, and FIG. 29 displays these same seven 5 min bars in the price chart of the stock WEC in this trading day. At 14:36 EST of that day, the filter E found the #4 bar with its closing price above the prior two 5 min bars. A new data line 275 is shown in FIG. 27. This result is also shown in FIGS. 29 and 30.

An up green arrow 284 is placed below the 5 min bar #4 in FIG. 29. The same arrow is also listed in the alert column of FIG. 27 list/filter sheet. This arrow has two “up wings”, which can be interpreted as sign for a closing price above two prior 5 min bars. Other alerts such as flashing and vocal announcement may also be incorporated to alert the user for this event.

It is to be noted that for both the filters C and E, it is the closing price of the 5 min bar that is to be used for the filtering. There is no consideration whether this 5 min bar is a green or red bar. In the case of the filter E, if the closing price of the 5 min bar is above the two prior bars, this bar is above the two prior bars regardless whether this bar is a green bar or red bar. But this is not true in the case of filter C. As seen in FIG. 29, there is no up green arrow assigned to the bar #7 by the filter E. But the filter C would have declared a green up arrow to this bar because the closing price of this bar is above the closing prices of two prior 5 min bars, in spite of the fact that this bar is below the bar #6.

A brief description can also be offered here for a user choosing a filter E for finding stocks each having a 5 min bar with its closing price above three prior bars. FIGS. 27′, 28′, 29′, and 30′ are shown replacing FIGS. 27, 28, 29, and 30, respectively, for this filter. The difference between these two filters E is clearly shown in their flow diagrams in FIGS. 28 and 28′.

At 14:36 EST of that trading day, the operation of the present filter E on the WEC stock discovered a 5 min bar #4 with its closing price above three prior 5 min bars. This result is also confirmed in FIGS. 29′ and 30′. A new green up arrow 288 is shown placed below the bar #4 in FIG. 29′. This arrow has three “up wings”, which can be interpreted as sign for the closing price of this bar above its three prior bars. A same up green arrow is also placed in the alert column of the closing price-bar list/filter sheet, as shown in FIG. 27′, along with other data in its new data line.

The use of the filter E for filtering all stocks each having a 5 min bar with closing price below last two or three 5 min bars are also available as seen in FIG. 5. The concept of filter E of the present invention can also be expanded for filtering a list of stocks for finding stocks each having a 5 min bar with closing price above or below last four or more 5 min bars.

### Filter F: Three Line Break (TLB)

The use of TBS is unique to the RTO-PRO program. But one other trend reversal called Three Line Break, TLB, is really even more popular among many real time stock market software programs. This TLB, which was originally referred to a bullish or bearish reversal after three same color 5 min bars, in the present application will be broaden to refer to a bullish or bearish reversal after any number of same color 5 min, or any other duration, bars.

FIG. 5 discloses a filter F 46 of the present invention. This filter will filter a list of stocks to find out the stocks each having a 5 min bar representing a bullish or bearish reversal after two or three same color 5 min bars. After clicking the filter F box, the user can choose whether this 5 min bar is a bullish or bearish reversal, after which, the user next decides whether this reversal is after two or three same color 5 min bars.

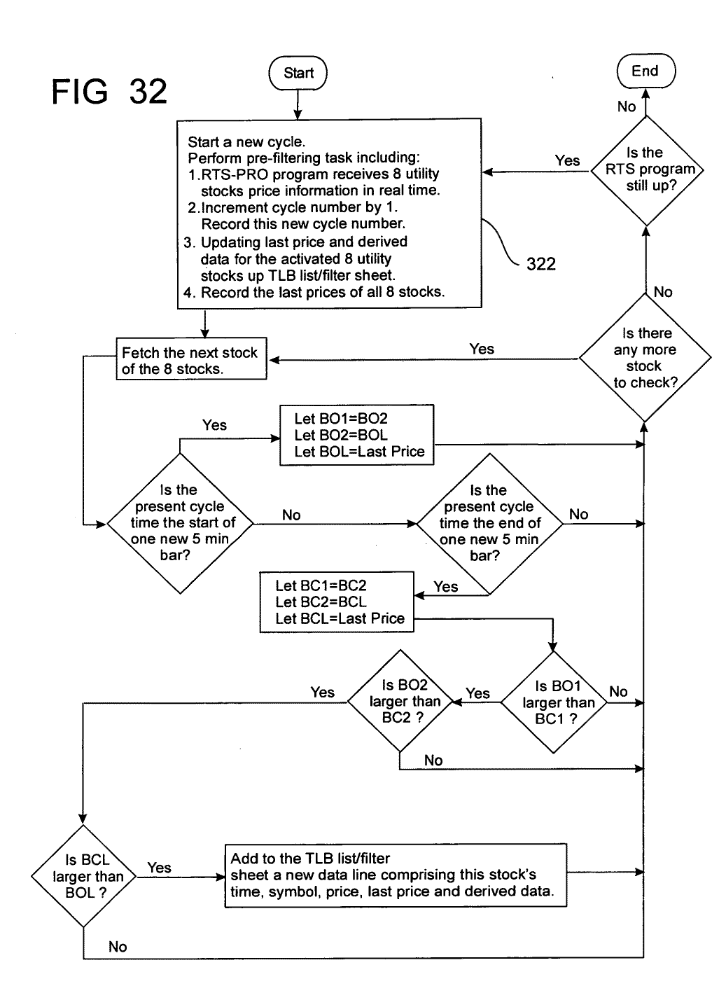

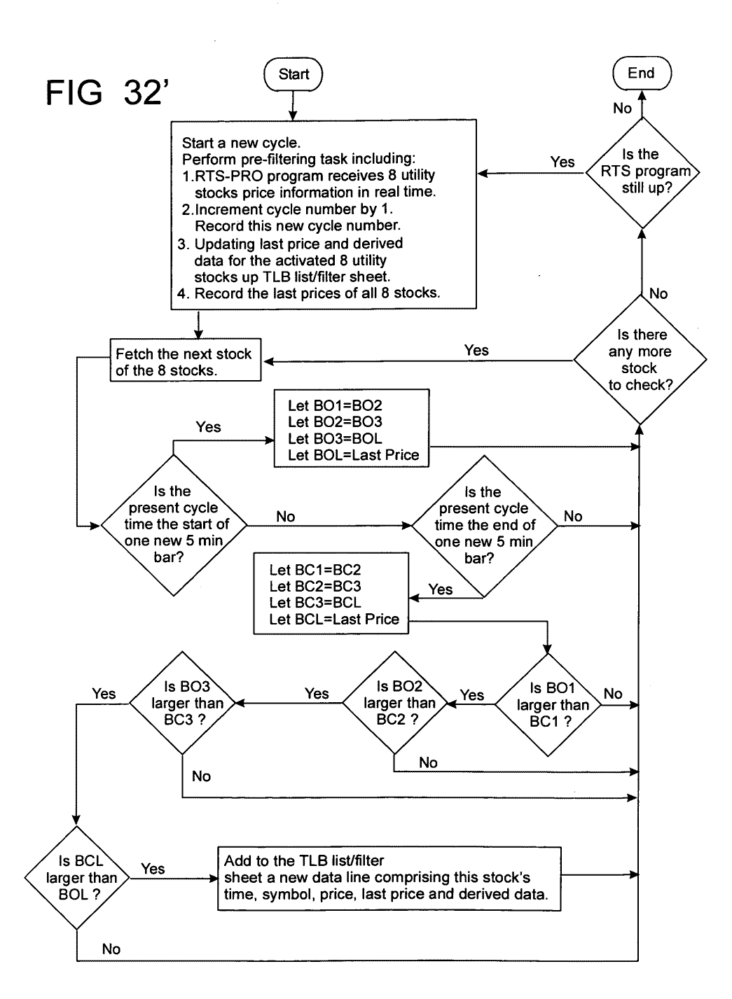

FIG. 32 is a flow diagram of the filter F for finding stocks, in a list of eight utility stocks, each having a 5 min green bar representing a bullish reversal after two prior 5 min red bars. As shown in this flow diagram, at start of each cycle, several pre-filtering tasks will be performed as outlined in the item 322, in FIG. 32.

Here, the stock WEC at trading day of Jul. 20, 2010 between 9:56 and 10:26 EST, will be used in the present example. The price chart of this stock within this time range is shown in FIG. 33, represented by six 5 min bars, with bar numbers from 1 to 6.

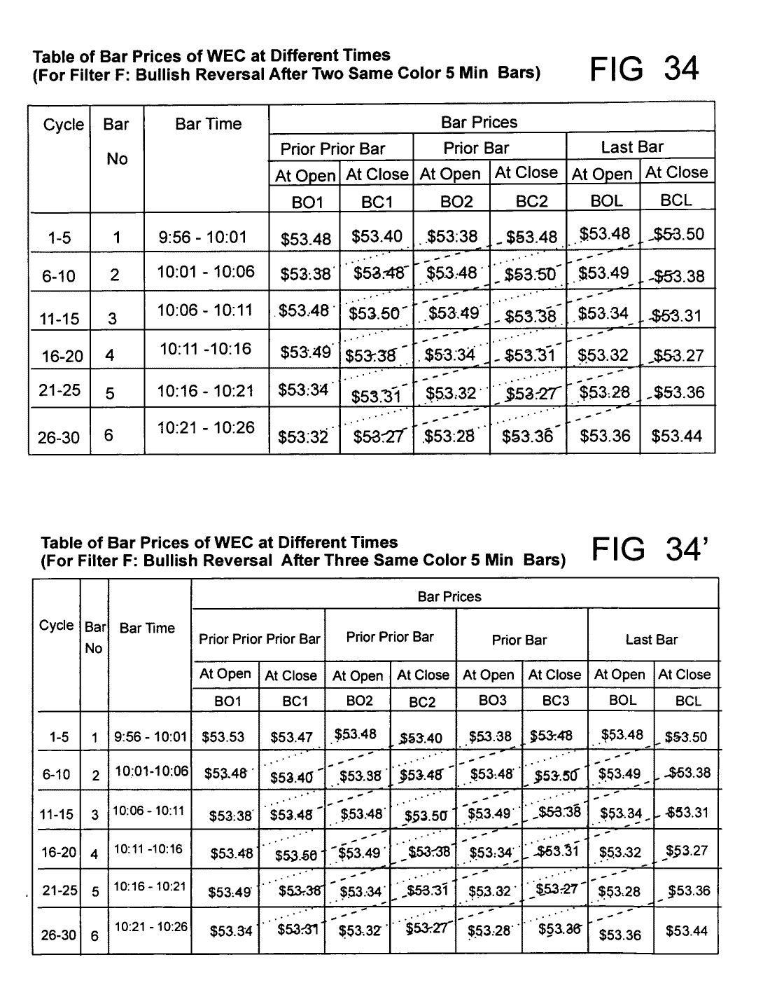

FIG. 34 is a table constructed as part of the present filtering process. It tabulates the cycles and time for each 5 min bar, as well as the opening and closing prices of each bar and its two preceding 5 min bars.

The following criteria are used for finding all TLBs in each closing cycle of the 5 min bar.

BO1>BC1

BO2>BC2

BCL>BOL

The first two lines decide whether all these two prior 5 min bars are red bars. The third line decides whether the present 5 min bar is a green bar, which represents a bullish reversal.

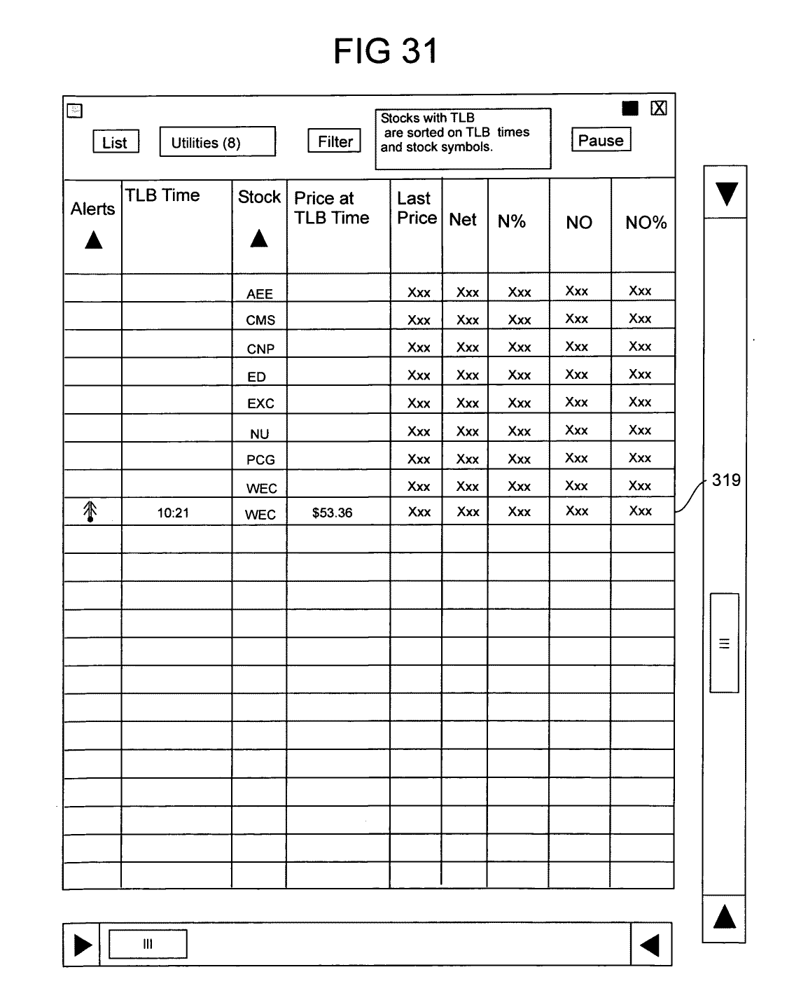

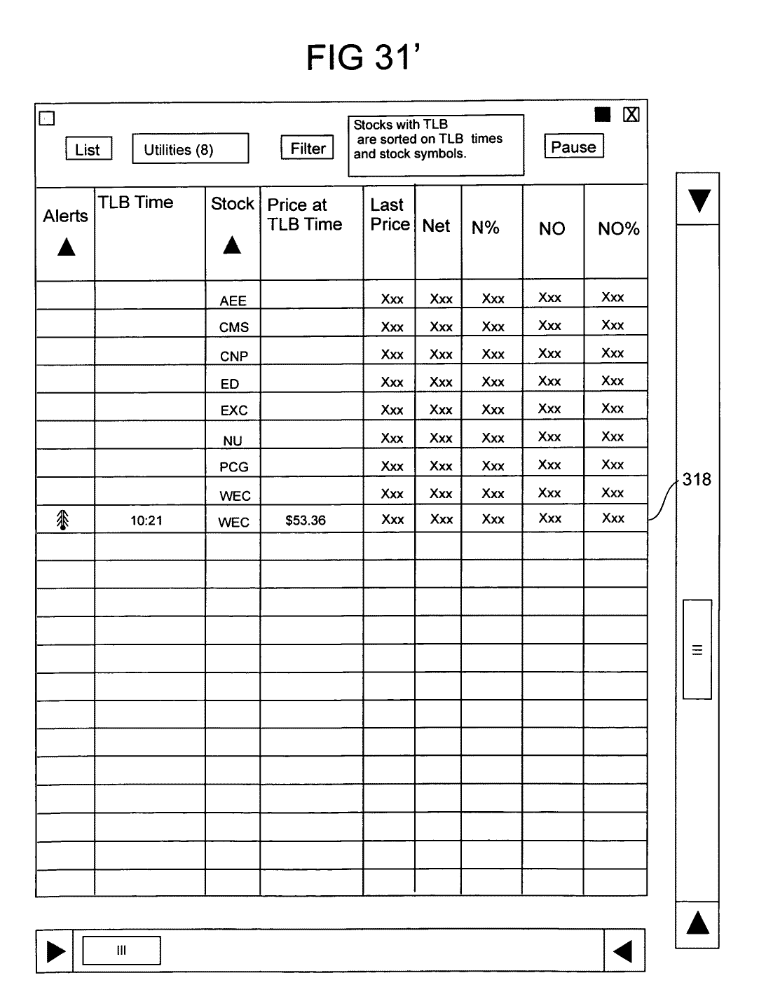

FIG. 31 shows a TLB list/filter sheet created after the selection of the filter F. Prior to the start of the filtering process this list/filter sheet only lists the eight utility stocks' last prices and associated derived data. With the progress of the filter process, a first TLB 5 min bar was found for the stock WEC at 10:21 EST. As instructed by the flow diagram in FIG. 32, a new data line 319 is placed on the TLB list/filter sheet, as shown in FIG. 31.

An up green arrow 344 is placed below the 5 min green bar #5 in FIG. 33 and in the alert column in FIG. 31. This arrow is shown with two “up wings” which may indicate a bullish reversal after two red 5 min bars. Other alert features including the flashing sign and the vocal announcement may also be provided to alert the user on the occurrence of this TLB event.

A brief description can also be offered here for a user choosing a filter F for finding stocks, each having a 5 min green bar representing a bullish reversal after three 5 min red bars. FIGS. 31′, 32′, 33′ and 34′ are shown replacing FIGS. 31, 32, 33, and 34, respectively, for this new filter F. The difference between these two filters F are clearly shown in their flow diagrams in FIGS. 32 and 32′.

At 10:21 EST that day the filtering of the WEC stock discovered a 5 min bar representing a bullish reversal after three red 5 min bars. As instructed in the FIG. 32′ flow diagram, a new data line 318 is created as shown in FIG. 31′.

An up green arrow 348 is placed below the 5 min green bar #5 in FIG. 33′, and in the alert column in FIG. 31′. This arrow is shown with three “up wings”, which may indicate a bullish reversal after three red 5 min bars. All above-described alert features may also be employed here.

The use of the filter F for filtering a list of stocks for finding all stocks each with a 5 min red bar representing a bearish reversal after two or three same color 5 min bars are also available as seen in FIG. 5. The concept of filter F of the present invention can also be expanded for finding stocks each with a 5 min bar representing a bullish or bearish reversal after four or more same color 5 min bars.

### Filter G: NO % D

As seen in FIG. 3, RTS-PRO employs two headings, NO 37 and NO % 36, for each listed stock. NO stands for net open, which states the change in price of each stock from the current day's opening price. NO % stands for net open percent, which expresses the percent change from the current day's opening. NO and NO %, as well as all other headings, typically refreshes every few seconds or less. A positive NO and NO % mean that the current price of the stock is higher than its opening price, while a negative NO and NO % mean that the current price is lower than its opening price.

For a stock, the value of NO % (stock) is typically driven by two force components. The first component is the net open percent of the market, or a reference, NO % (reference), such as $DJI or $SPX. The second component is a factor unique to this stock, due to the fundamental of this stock. A new term, NO % D, can be introduced as

$$\begin{matrix}NO \% D = NO \% ( stock ) - NO \% ( reference ) \\ or = NO \% ( stock ) - NO \% ( \$ SPX ) , if the reference is \$ SPX .\end{matrix}$$

Most average stocks will move up or down at the same rate as the reference, which means their NO % D value is zero or near zero. A positive NO % D for a stock means this is a strong stock with good fundamental. In an up market, or positive NO % ($SPX), the rate of increase in price of this stock is faster than that of the reference. In a down market, or negative NO % ($SPX), the rate of decrease in the price of this stock is slower than that of the reference. Investment in this stock will likely have profitability higher than that of an average stock during an up market, or a loss less than that of an average stock during a down market. It is suggested that a trade long can be placed in this stock, preferably during an up market, along with many other favorable market conditions. Conversely, a negative NO % D for a stock means that this is a weak stock with poor fundamental. It is suggested that a trade short be placed in this stock, preferable during a down market.

For a long trading based on the NO % D filter G 53 in FIG. 5, the user has the choice to decide whether the NO % D value must be above 0%, 1%, or any positive percentage entered by the user. This option will allow the user to adjust the total number of filtered stocks with best long trade profitability.

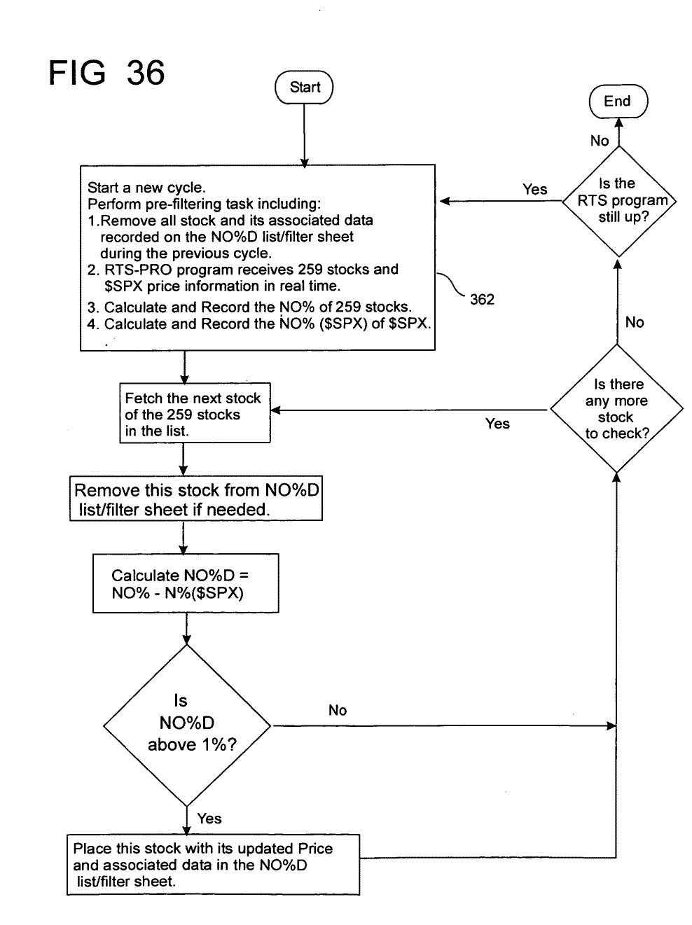

FIG. 36 shows the flow diagram for filtering the specified list of 259 stocks in order to find out in each cycle, all stocks that have NO % D value higher than 1%, and place all these stocks in a long NO % D list/filter sheet.

It is not necessary, but highly desirable; to also include a column listing all calculated NO % D data in all stocks in the list/filter sheet. The list/filter sheet shown in FIG. 3 has 11 data columns or headings displayed. But the current version of the RTS-PRO allows as many as 36 headings to be displayed in this sheet. A one time revision on the RTS-PRO can allow the NO % D as the 37th column displayable on the sheet. In this case, the NO % D column can be sorted according to the size of the NO % D value in order to find out the best-qualified stocks for analysis and trade.

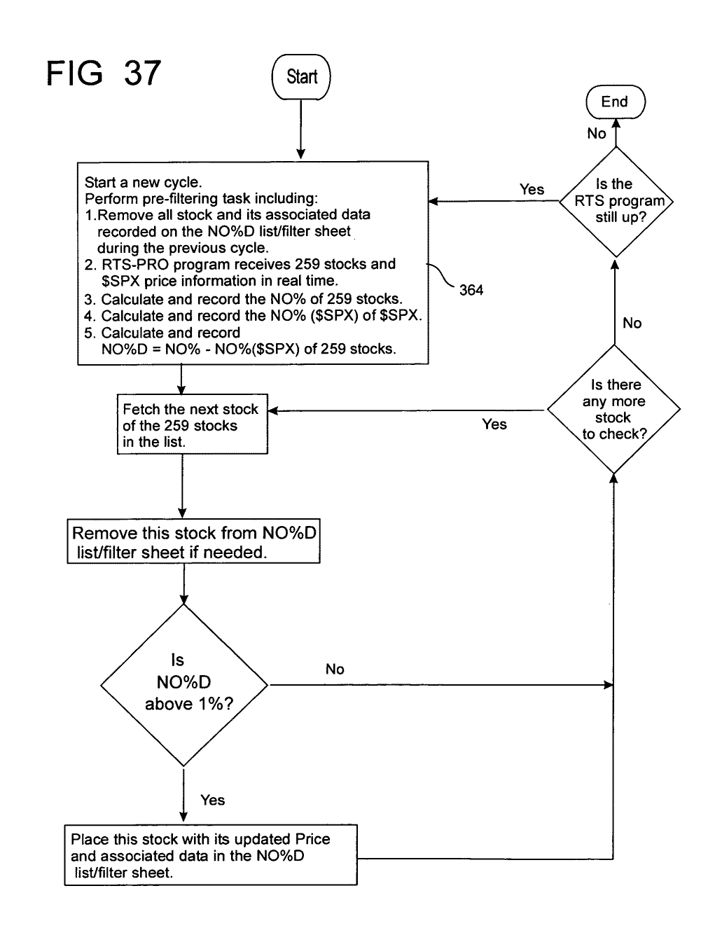

In FIG. 36, a step of the calculation of the NO % D is included. But if the NO % D is included as one heading, its value can simply be calculated internally since the value of the NO % (stock) and NO % ($SPX) are available as a function of time. In this case, the calculation step in the flow diagram of FIG. 36 will no longer be needed. The value of NO % D can be updated every few seconds or less just like all other headings. FIG. 37 is a flow diagram reflecting such a change of FIG. 36, that allows the calculation and recording NO % D of all 259 stocks, as part of the pre-filtering tasks indicated by the item 364 in FIG. 37. Consequently, the step of the NO % D calculation in FIG. 36 is no longer needed.

It is noted that the filter G is different from the filter C to F, which always involve the comparison of the current 5 min bar prices with the prices of previous 5 min bars. For the filter G no 5 min bar is needed. The only prices information needed are the downloaded prices of $SPX and all stocks in the selected list during each cycle.

The NO % D list/filter sheet is operated in the same manner as the list/filter sheet in FIG. 3. At the beginning of each cycle, all stocks and its associated data placed in the NO % D list/filter sheet in the previous cycle will be removed. During this cycle, only stocks and its associated data meeting the filter G criteria will be placed in the NO % D list/filter sheet.

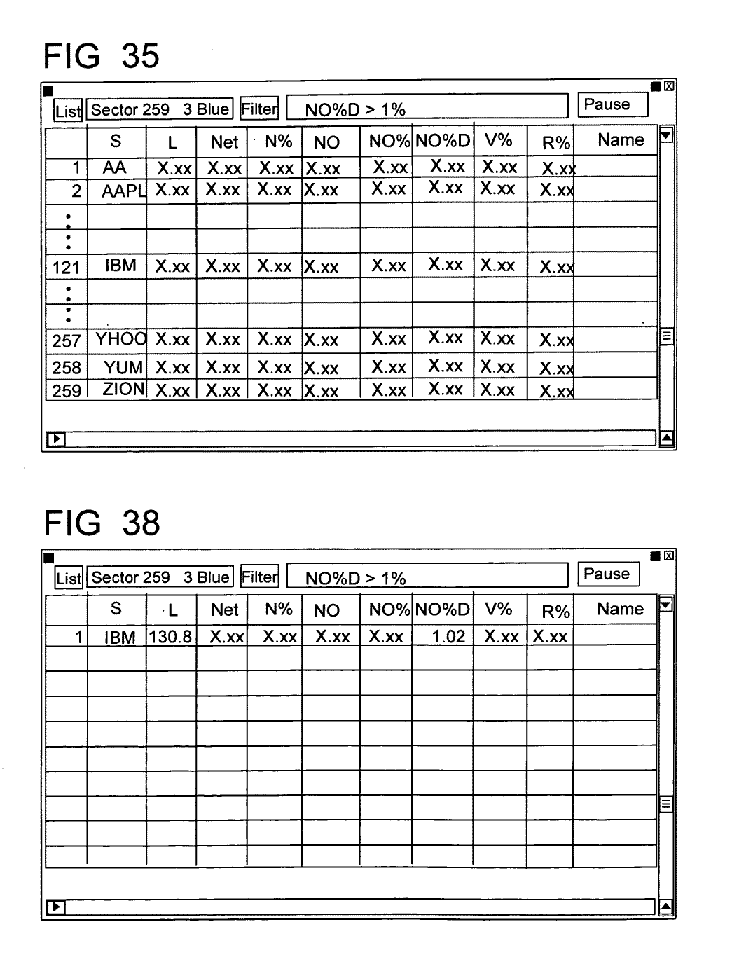

Prior to the stock opening on the trading day of Apr. 26, 2010, a click activation of the filter G for long will create a long NO % D list/filter sheet as shown in FIG. 35. This sheet shows the last prices of all 259 stocks and their derived data base on the prices at prior day's closing time. It is noted that data of NO % D for all 259 stocks are also included. All value in this sheet are marked by “X.xx”, which are not relevant for the following discussion.

For the sake of demonstration, it is assumed that during this trading day, only the stock IBM among the list of all 259 stocks will have a NO % D above 1%. During the first several hours after stock opening and activation of the filter G, all 259 lines of data are disappeared, because no stock has its NO % D value above 1%.

At 14:00 EST that day, the NO % D value of the stock IBM just exceeds 1.0% and was found by the filter G. The long NO % D list/filter sheet as shown in FIG. 38 will begin to show a line of data for the stock IBM. This line will continue to appear in this list/filter sheet as long as value of NO % D stays above 1% during the remaining time of this trading day. Each presented line of data will be continuously updated.

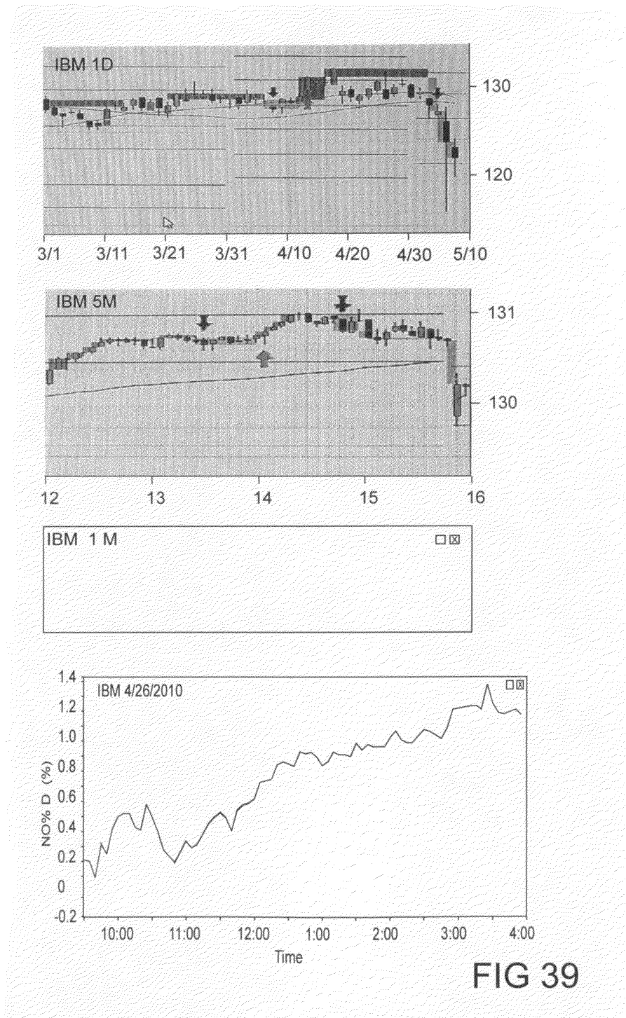

With the setup of the color link, three price charts of IBM (1D, 5M, 1M) can be displayed as shown in FIG. 39. Also shown in this figure is a chart of NO % D for IBM, which was manually created based on the available NO % (IBM) and NO % ($SPX) data, for the purpose of demonstration. With the available NO % D data, a real time plot of NO % D vs. time can be easily made and displayed through color linking, using the chart-making program available in the RTS-PRO software.

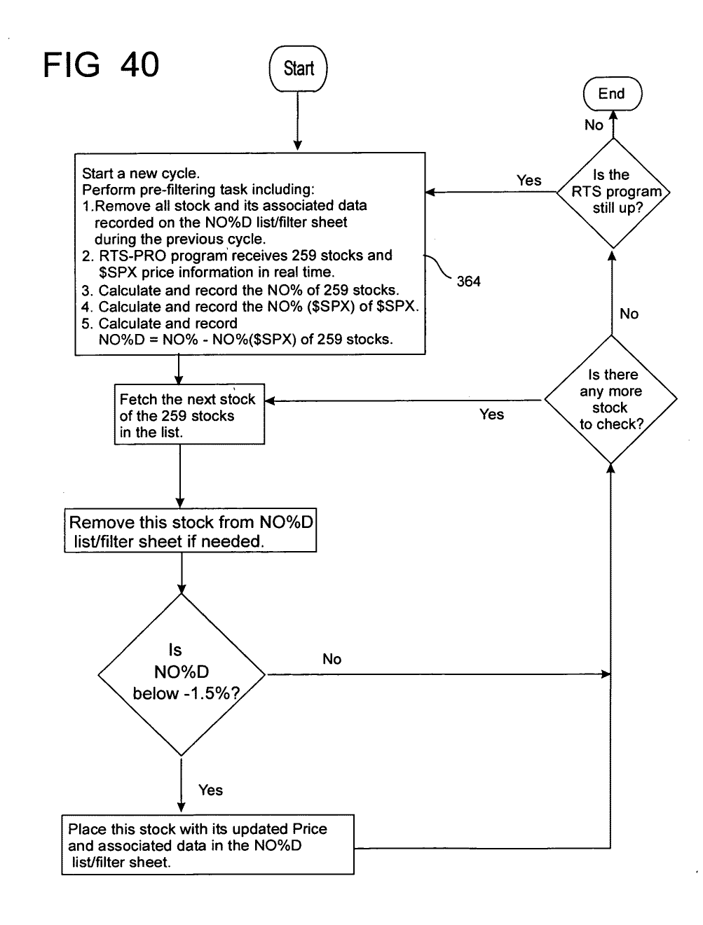

The filter G for trading short also allows the trader a choice to select whether the NO % D value must be below 0%, −1%, or any negative percentage entered by the trader. FIG. 40 shows the flow diagram for filtering the stocks in the data base in order to find all stocks that have NO % D value below −1.5%, a number entered by the trader. All found stocks can be placed in a list/filter sheet, which is color linked with a chart display window.

### Filter H: N % D

As seen in FIG. 3, RTS-PRO also employs two headings, N (Net) and N %, for each listed stock. N stands for net, which states the change from previous day's closing price. N % stands for net percent, which states percent change from previous day's closing price. A positive N and N % means that the current price of the stock is higher than yesterday's closing price. A negative N and N % means that the current price of the stock is lower than the yesterday's closing price.

Similar to NO %, the N % value of one stock can also be compared with the N % value of one reference. A new term N % D can be introduced, which equals to N % (stock)−N % ($SPX), if the reference is $SPX.

The filter H in FIG. 5 for trading long or short is very similar to the filter G for trading long or short, except by replacing the opening price by the yesterday's closing price. Compared with the filter G, filter H is more often used for multiple days swing trading.

The flow diagrams for filter H are not shown, but are very similar to the flow diagrams for filter G shown in FIGS. 37 and 40. In these cases, each character string “NO” must be replaced by the character “N”.

### Filter I: List

In the current version of RTS-PRO there is a limit of maximum of 300 stocks for each member that can be allowed in all lists maintained at any time. For example, on the day of Jul. 20, 2010, a list of 259 sector stocks (Basic Materials, Financial, Service, Technology) was maintained in a regular list/filter sheet along with a second list/filter sheet having eight utility stocks. A manual check of all price charts of these 259 stocks uncovers more than two hundreds up TBSs suitable for profitable long trades in that day.

With so many profitable trading opportunities available, the trader is certainly interested in entering as many trades as possible. But it is simply impossible for a trader to handle these two hundreds up TBSs trading by himself. Because after each entry, the trader must watch closely the price movement of this stock in its chart in order to exit as soon as this stock's price becomes stagnant or even falling. This is the essence of day trading in which a quick entry is followed by a quick exit in order to get out with a small profit and free up the fund for the next trade entry.

An experienced trader can usually watch four entered stocks simultaneously. An expert in trading may be able to handle up to eight entered stocks at a time, but not more. One possible solution of handling more trades is to split the trading job to two or more persons. This is suitable for a family with husband and wife, especially in retirement stage. It is even better if children in this family may also join in this effort.

The best way to split the trading job to two or more persons is also to create two or more list/filter sheets, one for each person to attend separately. Of course two or more brokerage accounts must also be established, which is easy to do at no additional cost. Two or more TV displays of the list/filter sheets and linked price charts display may also be needed.

The next question to be answered is to find the best way to divide one large stock list, such as 259 sector stocks into two or more smaller lists, each with one list/filter sheet. One easiest way of splitting the 259 stocks is to divide up the 259 sector stocks into their separate sectors, such as basic materials sector (73) and service sector (60) in one sublist and Financial sector (35) and technologies (91) in the other sublist. One problem with such division is that in a typical trading day all stocks in one sector tends to move up or down in similar pattern, but quite different among different sectors. One possible result is that one sublist may have many up TBSs while the other sublist may have few or no up TBSs during a given time period. Such uneven division may defeat the goal of dividing up the job of trading among two or more persons.

Disclosed in FIG. 5 is a Filter I of the present invention for dividing a large list of stocks into two or more sublists according to the alphabets of the stocks' names or symbols. The user can simply click the box next to Filter I 47 twice to select a first list with the stock symbol first alphabets from A to K, and a second list with the stock symbol first alphabets from L to Z. This will allow two TBS list/filter sheets to be created for two persons to manage separately. This same large list of stocks may also be split into three or more sublists by clicking the Filter I box three or more times. In each time the option for stock symbol first alphabets from ______ to ______ will be selected. The user will have the freedom to set the ranges of the alphabets to produce approximately equal number of stocks in each sublist.

A user may also divide a large list of stocks, with assigned consecutive numbers, into two subgroups, one having even numbers and one having odd numbers. In general, the user may also divide a large group of stocks into x subgroups. Each stock with an assigned number can be moved to a subgroup according to the following formula:

1st subgroup: with a remain (=0) after dividing its assigned number by x
2nd subgroup: with a remain (=1) after dividing its assigned number by x
xth subgroup: with a remain (=x−1) after dividing its assigned number by x.

### Filter J: 1D TBS During The Trading Day

As seen in FIG. 5 and described above, the presently proposed Filter A enables a minute type up/down TBSs assigned on a 5 min or 1 min stock price chart to be timely reported for trading consideration. This filter also allows a 1D up/down TBS assigned to a 1D stock price chart to be timely reported.

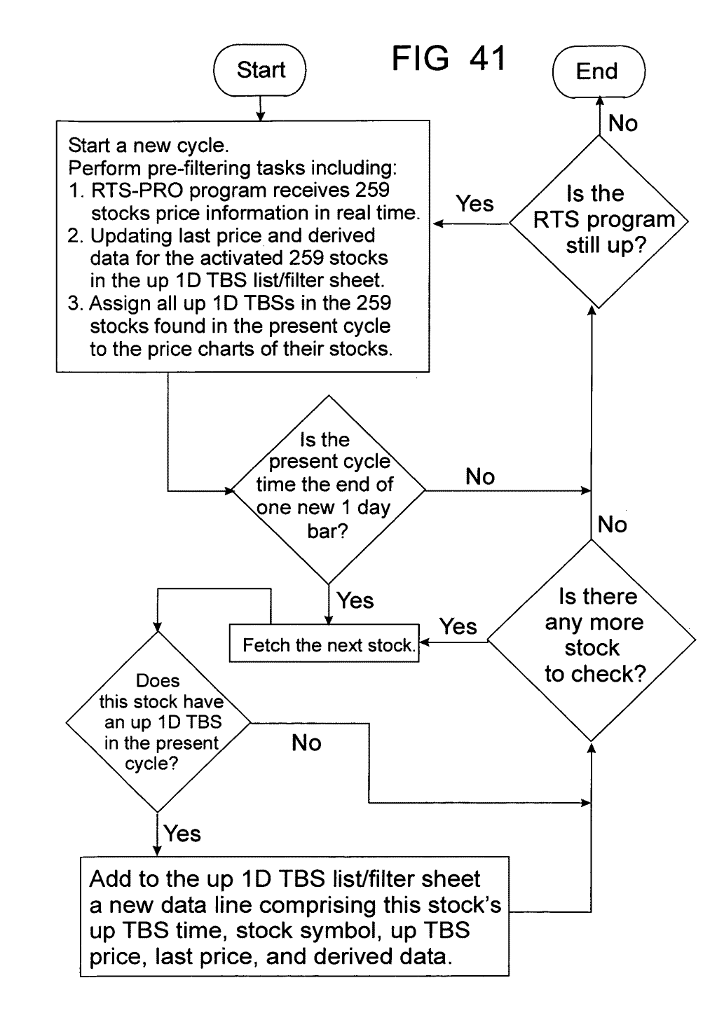

FIG. 41 shows a flow diagram for a 1D up TBS filter of the present invention. This flow diagram is virtually the same as the flow diagram for the 5 min up TBS filter shown in FIG. 6. The only difference is the length of the candlestick bar has been changed from 5 min to 1 day.

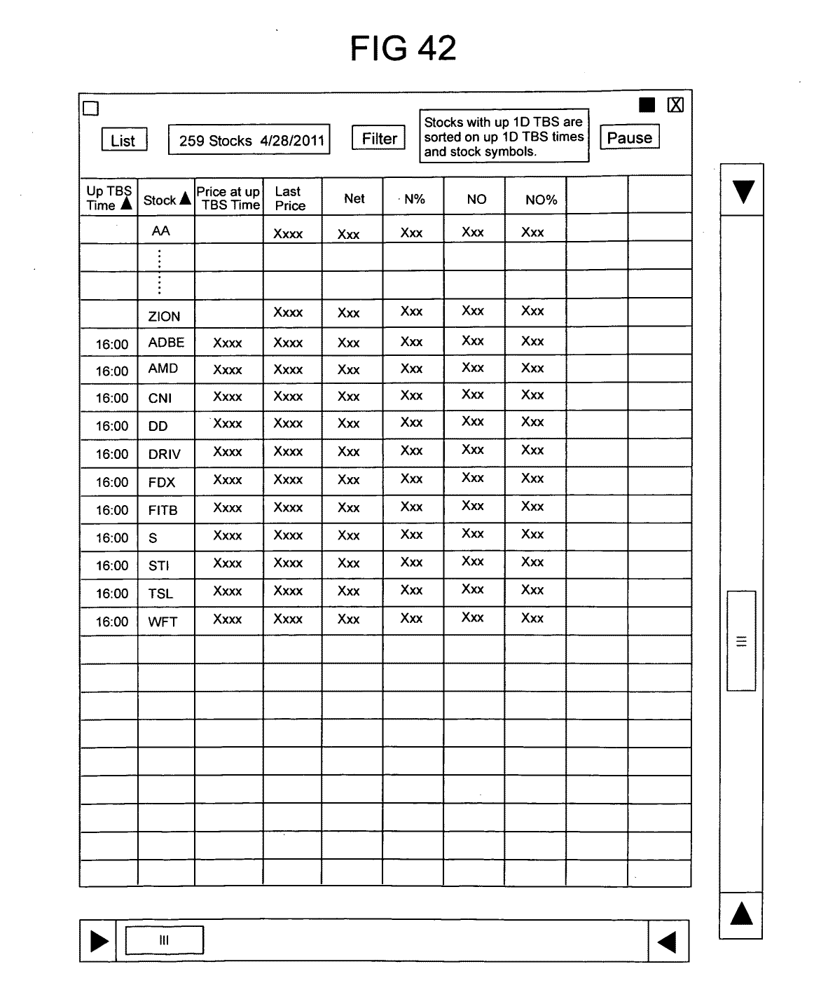

After clicking the “New Scan” button, the trader selects the 259 sector stocks as the list to be filtered. In the revised List Filter panel, he selects Filter A, 1D up TBS, and then clicks the “ok” button. A new 1D TBS List/Filter sheet will appear as shown in FIG. 42, but only including the list of 259 stocks prior to the filtering process.

After the start of the filtering process in the Apr. 28, 2011 trading day, nothing changes in the FIG. 42, which still only shows the 259 stocks, except that all last prices and derived data get updated after each processing cycle. However, a change suddenly happens right after the stock market is closed at 16:00 EST that trading day. A total of eleven lines of new data appear after the 259 stock list, as seen in FIG. 42.

Each of these eleven new data lines, in addition to the usual stock symbol, last price, and all derived data, also lists the up 1D TBS time and the up 1D TBS price. The reason why all these up 1D TBS time is 16:00 EST is because as seen in FIG. 41 flow diagram, the TBS list/filter sheet only gets updated once after one 1 day bar. If this sheet is linked with a layer of chart display, this layer will display these eleven stock price charts, each with one up green arrow placed below the 1D candlestick bar.

When an up TBS occurs in a stock's 1D price chart, it represents a bullish price reversal of this stock and possibly a strong momentum for upward price movement in the next few days. Such stocks may be favorable candidates for multiple days swing trading.

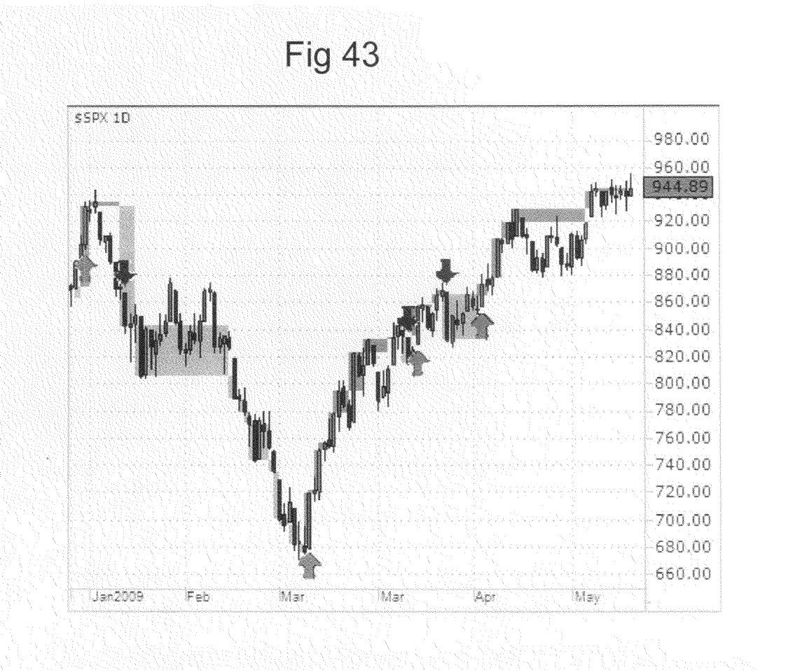

For the purpose of illustration, a 1D candlestick price chart of $SPX for the early part of year 2009 is shown in FIG. 43. An up 1D TBS is seen below the green bar of Mar. 9, 2009. This up 1D TBS signifies a strong bullish reversal of the overall market. Many individual stocks are expected to show similar bullish reversal near this date, and presents many profitable trading opportunities.

An up 1D TBS is ideal for spotting profitable multiple days trading potential. But it is also a signal pointing out later profitable trading opportunity on the same day if the up 1D TBS can be found prior to the close of the market. But unfortunately with Filter A, this 1D TBS signal was only assigned after the trading day is closed, and no more regular trade in that day can be made anymore. The question now is whether it is possible to spot this up 1D TBS not only after market close, but also during the same trading day, so a profitable trade can still be made during the same day based on this up 1D TBS signal.

With close inspection, it is found that the current RTS program starts checking the stock price right from the market open each day. It will assign an up/down 1D TBS any time when it finds the price meet the 1D TBS criteria. A 1D TBS arrow will be placed above or below the 1D bar only on a temporary basis, because this arrow will be removed any time when the stock price falls below the criteria. A 1D TBS will be placed in the price chart permanently only when the price meets the TBS criteria during the last cycle of the trading day.

Whenever an up/down 1D TBS appears in a stock's price chart during the trading day, this is the very time of bullish and bearish reversal, respectively, suitable for long or short trading of this stock. Actually, the price upward or downward momentum during this time just may be fresher and stronger than the momentum a day or several days later.

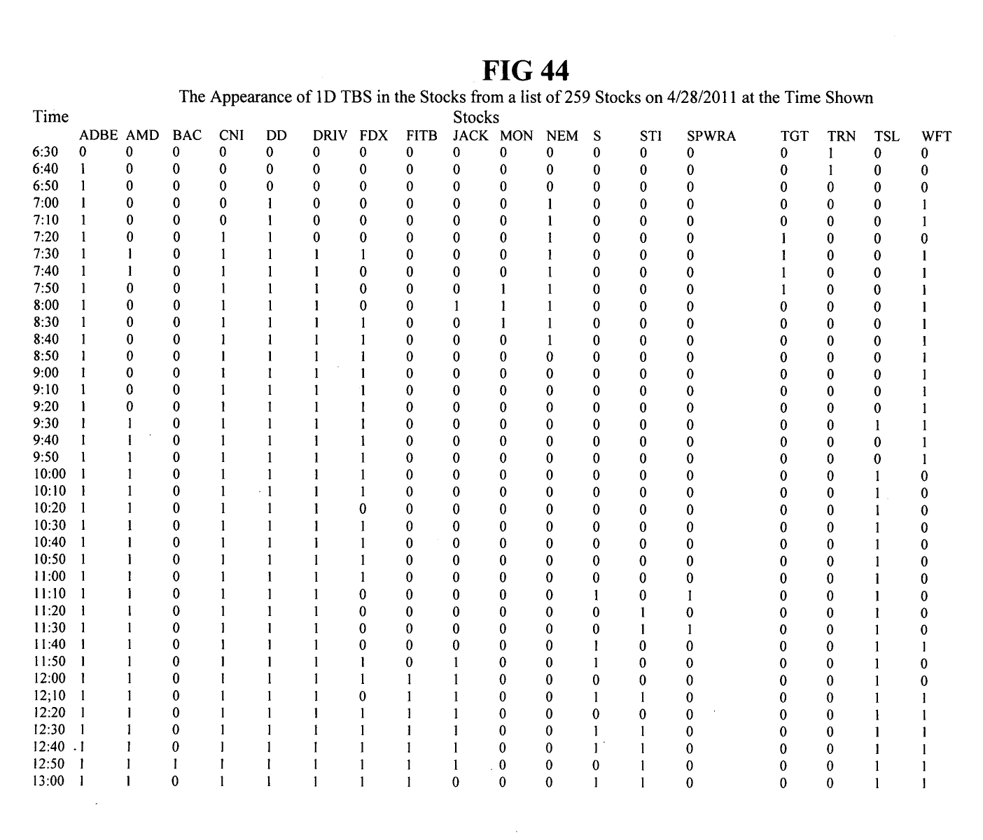

FIG. 44 is, through manual checking, a table showing the appearance (1) and disappearance (0) of 1D up TBSs in the stocks from a list of 259 sector stocks on Apr. 28, 2011 trading day at the time shown. During this trading day a total of 18 stocks, each having an up 1D TBS appearing at least once as shown in this table. In the last cycle of this trading day, only eleven stocks still retain its up 1D TBSs, same as shown in the list/filter sheet in FIG. 42.

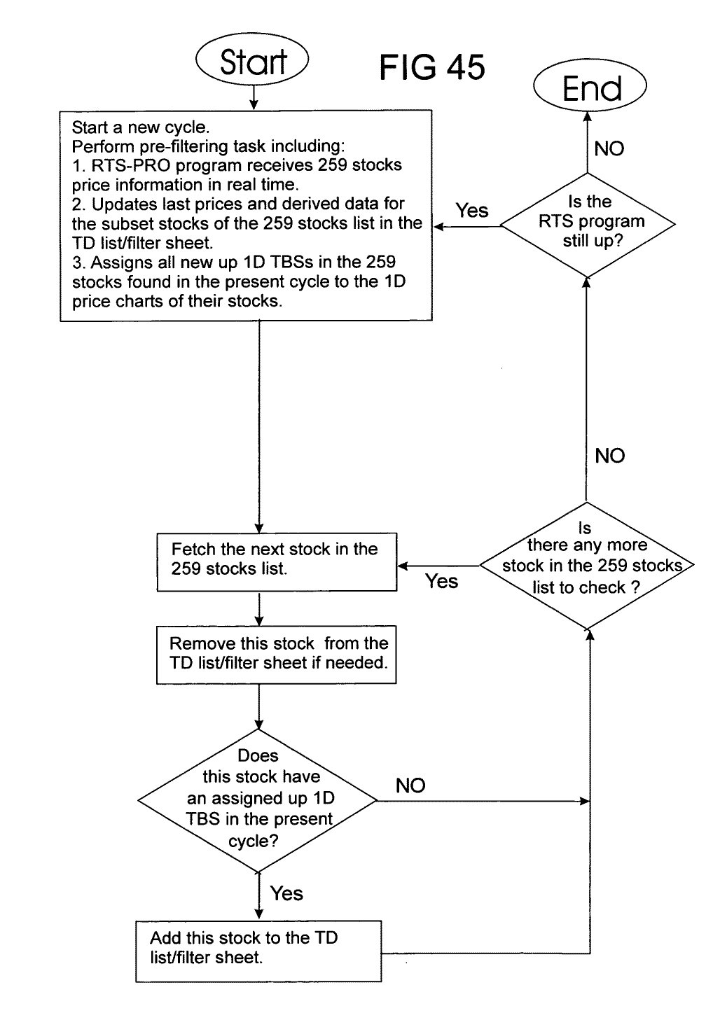

In order to take advantage of the appearance of an up 1D TBS during a trading day (TD), a new filter, Filter J in FIG. 5, is proposed. Shown in FIG. 45 is a flow diagram for Filter J. After clicking the “New Scan” button, the trader selects the 259 sector stocks as the list to be filtered. In the revised List Filter panel, he selects Filter J, 1D up TBS During The Trading Day, a new 1D Up TD TBS List/Filter sheet will appear, but only showing the list of 259 stocks prior to the filtering process.

Different from the Filter A, the Filter J works in the same manner as a typical filter used in the existing RTS-PRO program. In each operational cycle, the filter will check a list of stocks to find out a sub-list of stocks, each of which meeting the criteria of the filter. This sub-list of stocks will then be placed in a list/filter sheet, replacing all stocks placed there in the previous cycle.

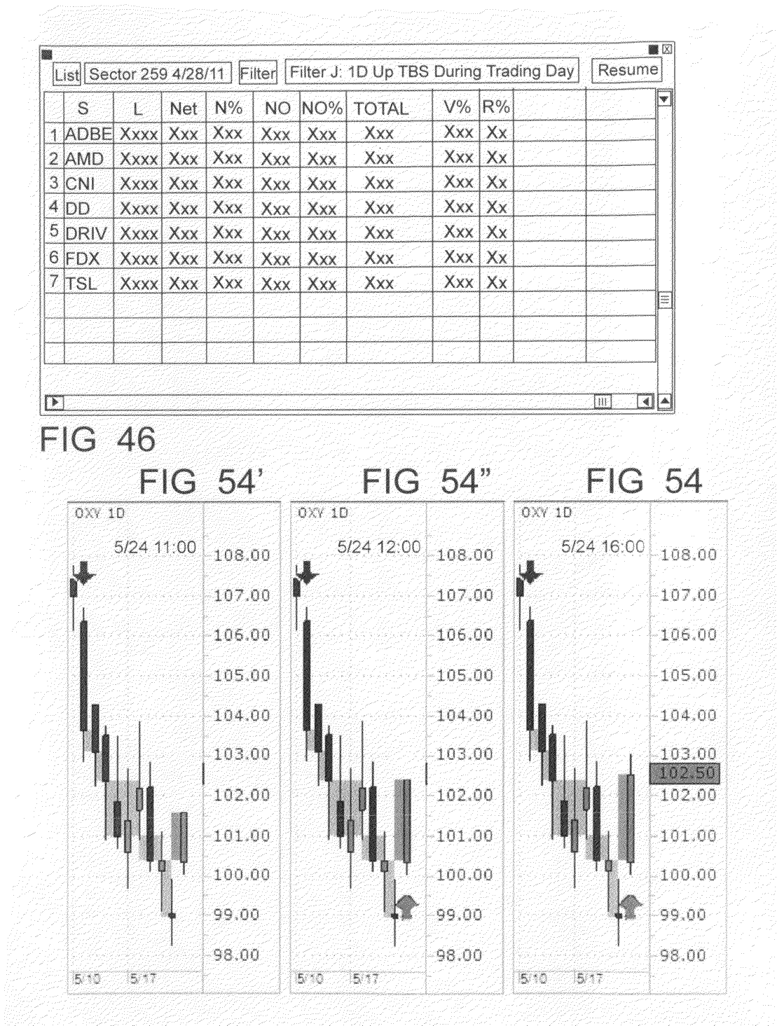

Immediately after the open of the market on Apr. 28, 2011, the 259 stocks in the 1D Up TD TBS List/Filter sheet are replaced by a sub-list during the first operational cycle of the filter. Through manual checking of the obtained data as shown in FIG. 44, this sub-list will consist of only one stock TRN at 6:30 EST. A total of seven stocks were listed in the sheet at 10:00 EST as shown in FIG. 46, which was copied from the FIG. 44 table. By the close of the market in that day, this list should go up to eleven stocks, which are also shown in FIG. 42.

The invention of the Filter J opens up the possibility to stock trading based on the 1D up/down TD TBS in the same trading day from stock opening to close. All stocks appearing in the 1D Up TD TBS List/Filter sheet are the stocks currently experiencing a bullish price reversal with strong momentum of price increase in both this trading day and possibly, especially if the TBS sign stays on during the rest of this day, more days ahead.

For the sake of discussion, it is assumed that all filters in FIG. 5 including the Filter A 1D Up TBS and Filter J 1D Up TD TBS have been successfully created as part of the revised RTS-PRO program. On May 24, 2011 the trader starts both these two filters. After the stock opening, the Filter A opens a 1D Up TBS List/Filter sheet similar to what is shown in FIG. 42, but only displaying the original 259 stocks. The Filter J opens a 1D Up TD TBS List/Filter sheet, similar to the one shown in FIG. 46, but displaying only four stocks AEM, AMX, BHI and NOV. Each sheet is linked with a 1D and 5 min charts.

In the 1D charts of these four stocks, four trading day 1D green candlesticks are shown, each accompanied with one green 1D TBS signal. These four stocks are ideal candidates suitable for single day and multiple days, including option, trading. Again before the actual trade entry, the trader must also check other indicators such as the overall market trend, trade volume, VWAP, etc., to make sure all these indicators are also favorable for long trade.

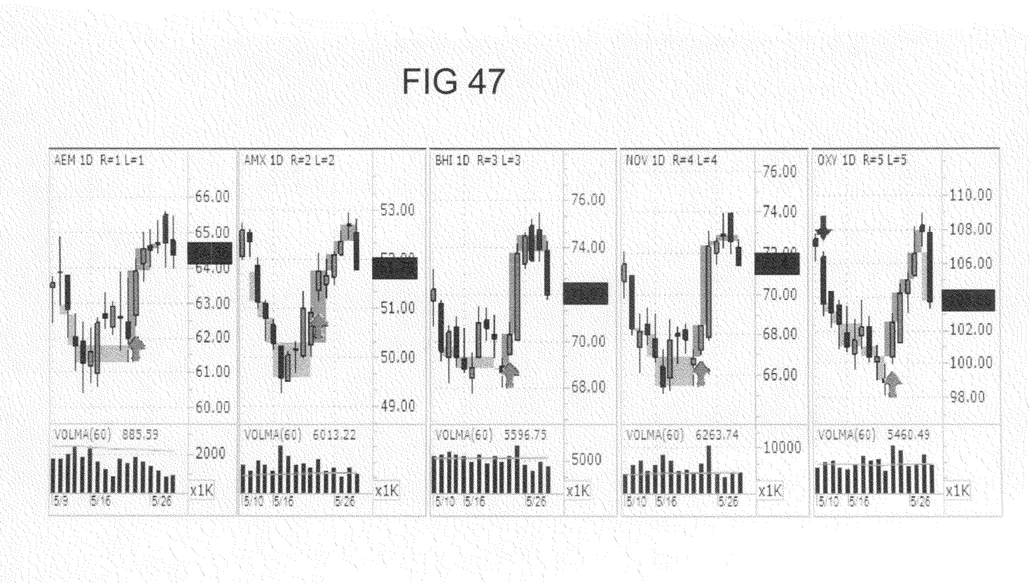

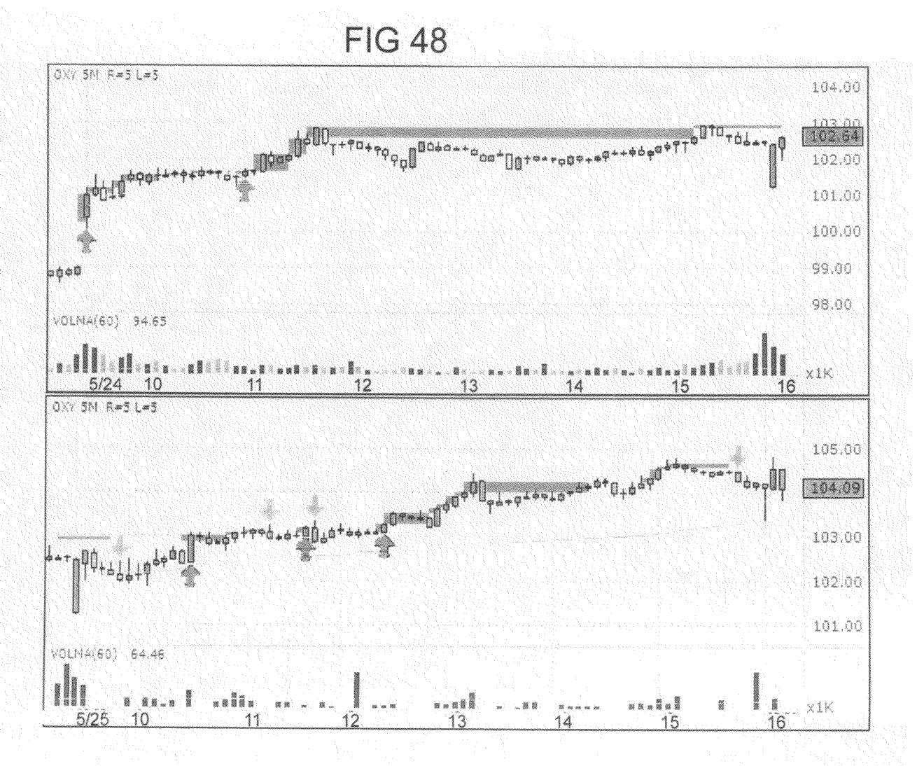

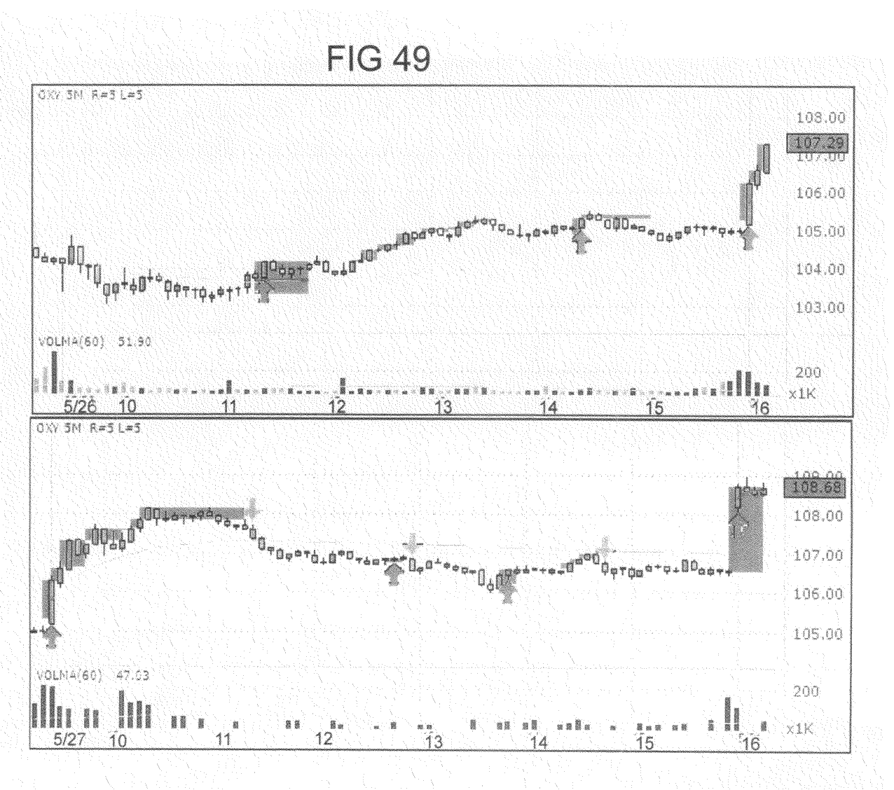

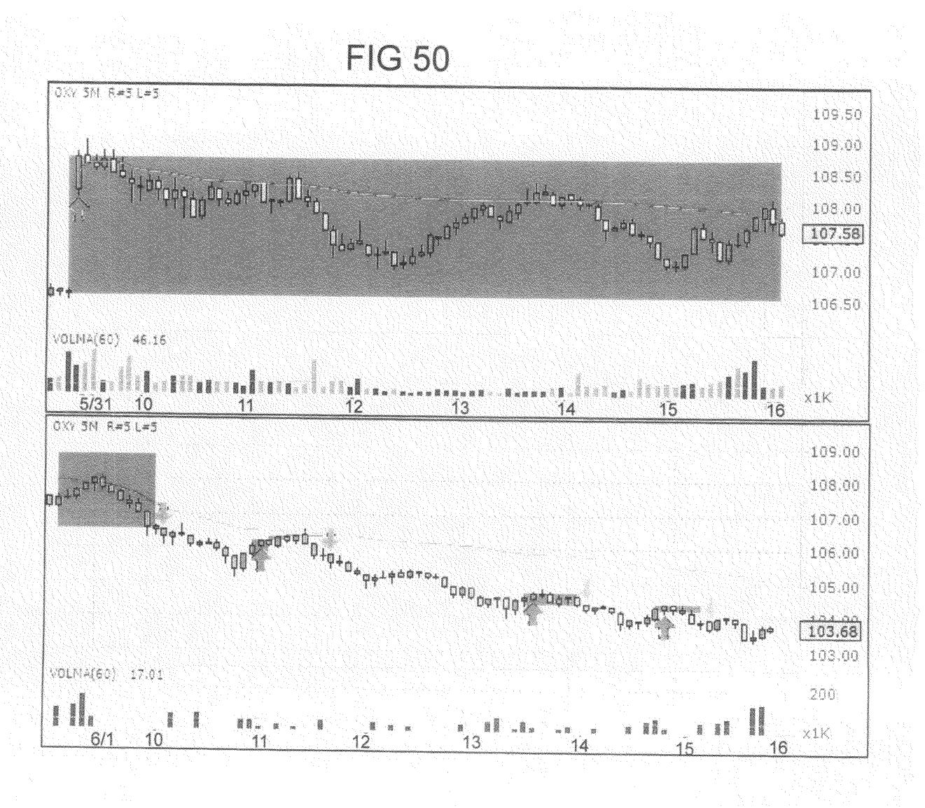

At 12:00 EST of May 24, 2011, a new stock OXY pops up in the 1D Up TD TBS List/Filter sheet. The trader decides to follow closely on these five stocks in the next few days for trading consideration. FIG. 47 shows the 1D charts of these five stocks recorded after the market close on Jun. 1, 2011. The 5 min charts of the stock OXY on six trading days started from May 24, 2011 are also provided in FIGS. 48, 49 and 50 for a discussion on the one day and multiple days swing trading based on the May 24 1D TD TBS of OXY.

The 1D chart of OXY shown in FIG. 47 is re-plotted in FIG. 54, at different scale, covering different date range, and recorded at market close at 16:00 EST that day. FIG. 54′ is a re-constructed 1D chart of OXY at May 24, 2011 11:00 EST, at which time no 1D TBS was assigned. FIG. 54″ is a re-constructed 1D chart at May 24, 2011 12:00 EST, at which time a 1D TBS was first found. Both re-constructed 1D charts were obtained manually based on the May 24, 2011 5 min chart of OXY shown in FIG. 48, which indicates that the price of OXY at 11:00 EST that day is $101.60, and $102.40 at 12:00 EST that day. Apparently, an up 1D TBS was triggered when the OXY price reached somewhere between $101.60 and $102.40, at time between 11:00 EST and 12:00 EST that day. Both these two re-constructed OXY 1D charts can be observed on the computer screen in real time at the time indicated. But no permanent records are maintained by RTS-PRO after the market close.

After the sudden pop up of the 1D Up TD TBS on the OXY, the trader quickly checks the linked 1D and 5 min charts of the stock. The 1D chart of OXY is shown, as in FIG. 54″, with an up TD TBS below the green bar. The 5 min chart of OXY on May 24, 2011 shows that at 12:00 EST the candlestick trace is on the tail end of a wave just peaked shortly before 12:00 EST that day. The trader made a long trade of 200 shares at 12:35 EST for $101.80/share. This point is at the valley of the wave just before the rise of price in a next wave. He adopts the practice of selling half of his purchase in the same day, while holding the other half for multiple days trading.

On the second and third days, the trader made trade entry early on based on his belief of the strong up momentum by this 1D TBS signal. The early day green 1D bars on both days also help him with his decision.

On the fourth day (5/27), the earlier rise of the stock price tells him to wait. He made a trade entry at 12:45 EST on the 5 min up TBS signal. It did not pan out but still with a small gain on the same day exit part.

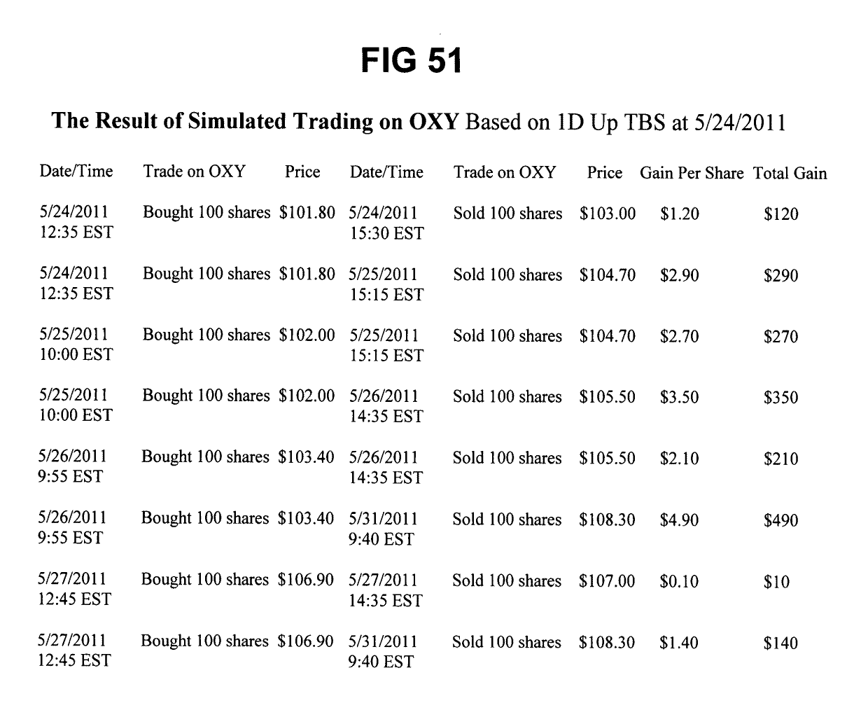

At the opening of the market on May 31, the day after the Memorial Day, the trader was shocked by the big 5 min gap up followed by a strong green bar. The succeeding price stagnation tells him this is a typical warning of price correction, although he doesn't know how big a correction this may be. He decides to exit all his OXY holdings. He was lucky to exit in time to avoid the coming collapse in the stock market starting the next day. FIG. 51 shows a summary of his simulated trading of OXY in these five days. The total gain of the OXY trading in these five days is $1,880, of which $610 is through day trading, and $1,270 is from multiple days trading.

Filter A Download: Stocks with 1D TBSs at Market Close

It is clear from the above discussion that it may be profitable in trading long or short for both day trading and multiple days trading based on the up or down 1D TBS. The best candidate stock for such trading would be a stock with strong bullish or bearish price reversal and a 1D TBS for achieving a price movement similar to the chart shown in FIG. 43.

In a typical trading day only one in sixty stocks may show an up or down 1D TBS. Since the current RTS-PRO program, due to its computer computation restriction, can only allow each user up to 300 stocks for its daily processing, it means that each user can only find about 5 stocks having such up or down 1D TBS in a typical day. Because not every stock with 1D TBS can lead to profitable trading, a trader may only achieve five or less profitable trading each day based on the 1D TBS strategy.

It is proposed that instead of increasing the number of stocks processable for hundreds and thousands users members, the Betrader Company can designate one key person with his computer and revised special program, to get access to 3,000 or more stocks for processing the 1D TBS filter. This is possible for US stock market, which has more than 10,000 stocks available for trading. It is reasonable to expect that by increasing tenfold the number of stocks to be processed, the number of stocks having 1D TBSs should also be increased from just 5 to 50. The Betrader Company may download such 50 stocks to each user on a fee basis every trading day. This should allow each sign—up user far more profitable trading based on 1D TBS each day. Since these 50 stocks is still far less than 300 stocks limit, such user may also pursue other type of trading strategies.

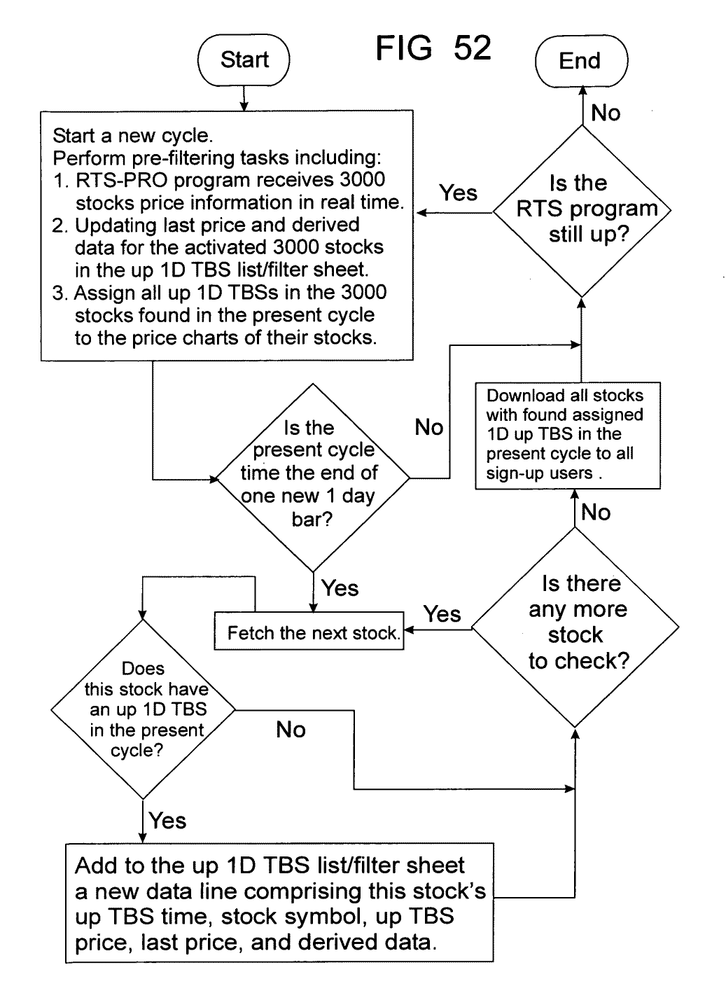

FIG. 52 shows a flow diagram for processing the Filter A in filtering a list of 3,000 stocks for finding the stock sub-list each having a 1D Up TBSs at the market close time. This flow diagram is essentially the same as the flow diagram of Filter A shown in FIG. 41, except for the fact that the current filtering is carried out only at the Betrader site, and the obtained stock sub-list will be downloaded to each sign-up user.

In this flow diagram the process of download itself is also treated as part of the automated subroutine program. But this download can also be done in a manual mode, through e-mail after market close, for example. In this case, in the receiving end, the user may need to perform some manual steps to make use of the received stocks.

With the activation of the Filter A Download 61, the initially created list/filter sheet will include the list of 3,000 stocks. At the close of the trading day this list/filter sheet will be similar to the list/filter sheet shown in FIG. 42, except all found stocks with assigned up 1D TBSs will be added below the 3,000 stock list. But during the download, only these stocks with assigned 1D up TBSs, not the original 3,000 stocks, will be downloaded to each sign-up user.

### Filter J Download: Stocks With 1D TBSs During The Trading Day

The Filter A Download described in the last section may provide stocks with 1D TBSs suitable for multiple days trading. But it can't help on the 1D TBS day's trading. It is proposed that a Filter J Download also be similarly programmed to filter 3,000 stocks list for finding and downloading sub-list stocks each having 1D TBSs during a trading day from stock open to stock close.

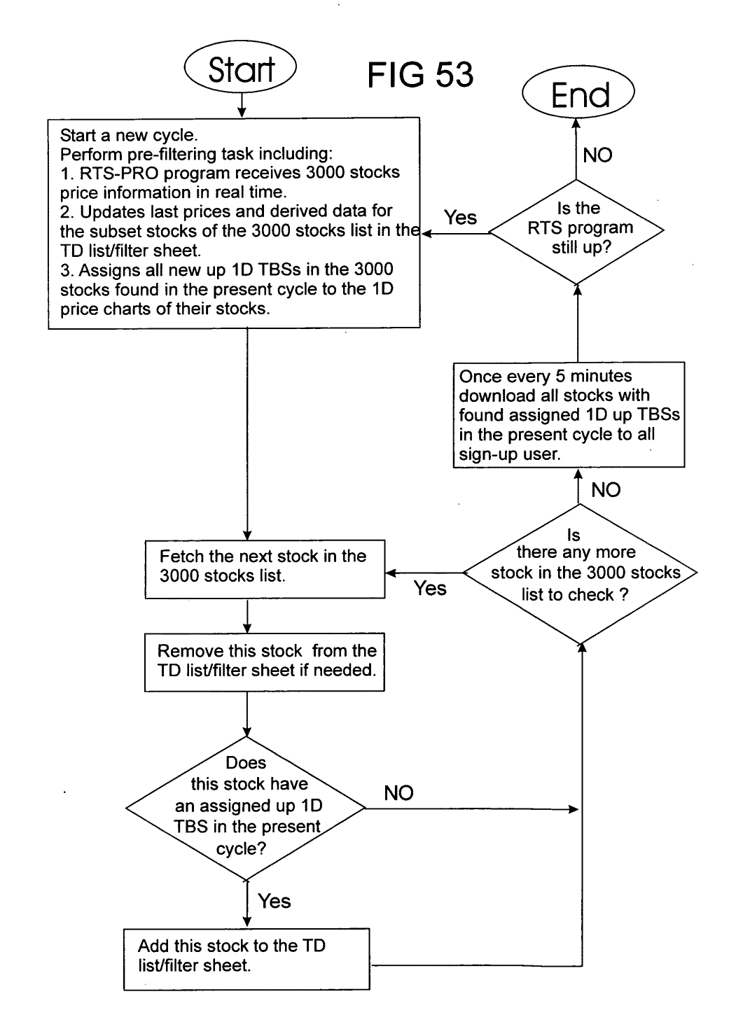

FIG. 53 shows a flow diagram for this Filter J. Download. This flow diagram is also similar to the one for Filter J itself, as seen in FIG. 45, except for the download section. Once this filter is activated, a TD list/filter sheet is created. A new stock sub-list will appear on this sheet once every cycle. However, instead of doing download in each cycle, only one new stock sub-list will be downloaded to each sign-up user every 5 minutes in order to reduce the load. The use of 5 min is somewhat arbitrary. It is chosen because one linked chart is a 5 min chart. But it can also be downloaded hourly or once every one or more minutes.

Due to the high frequency of this download, the whole download operation must be done in an automated fashion. A similar TD list/filter sheet must also be created in each user's site. During each download, this user's TD list/filter sheet must first be rid of the old sub-list before a new stock sub-list is downloaded. A linked chart display must also be provided for the user to view the charts of all downloaded stocks for trading.

The Filter J Download operation will provide download of stocks with 1D TBSs during the entire trading day helpful for both 1D TBS day trading and multiple days trading. It is suggested that after the close of market, all stocks actively traded for multiple days be manually transferred to a new quote list sheet to be monitored during the coming days. Some of these traded stocks may no longer be present in the TD list/filter sheet after the market close.

The same TD list/filter sheet may also be activated in the next trading day and be ready to receive more download of promising stocks in this new day. After several days operation, there is a possibility that the accumulated downloaded stocks may exceed the limit of 300 stocks. The user must be selective to retain only those stocks with promising potential. In the mean time reserve enough room to receive more download.

The invention having thus been described, the following is claimed:

1. A method of providing a user real time stock market data during a stock market day, and information helpful for market entry, comprising the steps of:
A. running a software program for obtaining real time stock market data for a list of stocks,
B. generating price charts and trend box signals for a group of stocks in said list of stocks, and placing said trend box signals on said price charts, and
C. executing a filter for filtering said group of stocks for reporting the appearance of at least one trend box signal of said trend box signals.

2. The method of claim 1, in which said filter includes means for
(a) generating a filter sheet, and
(b) adding a new data line in said filter sheet, indicating the appearance of said one trend box signal.

3. The method of claim 2, in which said new data line includes a signal.

4. The method of claim 2, in which said new data line includes the time of the appearance of said one trend box signal.

5. The method of claim 4, in which said time of the appearance will stay unchanged during said stock market day.

6. The method of claim 1, in which said filter includes means for offering an alert calling the attention of said user on said appearance of said one trend box signal.

7. The method of claim 6, in which said alert is a colored arrow sign.

8. The method of claim 6, in which said alert is a flashing colored arrow sign.

9. The method of claim 6, in which said alert is a vocal announcement.

10. The method of claim 1, in which
(i) said price charts are minute price charts, each having a series of minute bars, and
(ii) said trend box signals are minute trend box signals, placeable in said minute price charts.

11. The method of claim 1, in which
(a) said price charts are day price charts, each having a series of day bars, and
(b) said trend box signals are day trend box signals, placeable in said day price charts.

12. The method of claim 11, in which said reporting is downloadable to said user through Internet at the close of one stock market day.

13. The method of claim 11, in which said reporting is downloadable to said user through Internet periodically during one stock market day.

14. A method of providing a user real time stock market data during a stock market day, and information helpful for market entry, comprising the steps of:
A. running a software program for obtaining real time stock market data for a group of stocks,
B. generating price charts for said group of stocks, each of said price charts having a series of price bars, and
C. executing a filter for filtering said group of stocks against a pre-set filtering criteria for
(a) generating a filter sheet, and
(b) adding a new data line in said filter sheet, once any one stock in said group of stocks is found meeting said filtering criteria.

15. The method of claim 14 in which said filtering criteria asks whether said one stock has a price bar with its closing price higher than the closing prices of two prior price bars.

16. The method of claim 14 in which said filtering criteria asks whether said one stock has three consecutive price bars of rising prices.

17. The method of claim 14 in which said filtering criteria asks whether said one stock has a price bar with its closing price higher than two prior price bars.

18. The method of claim 14 in which said filtering criteria asks whether said one stock has a price bar representing a bullish reversal after two prior price bars of falling prices.

19. The method of claim 14 in which said data line reports the time when said one stock is found meeting said filtering criteria.

20. The method of claim 14 in which said filtering criteria asks whether said one stock has an up trend box signal placed on the price chart of said stock
